(19) United States
(12) Patent Application Publication
(10) Pub. No.: US 2013/0010239 A1
(43) Pub. Date: Jan. 10, 2013

(54) DISPLAY SUBSTRATE AND METHOD OF REPAIRING THE DISPLAY SUBSTRATE

(76) Inventors: Jae-Hyun PARK, Gyeoggi-do (KR); Seung-Sok SON, Chungcheongham-do (KR); Yu-Jun KIM, Chungcheongnam-do (KR); Man-Hong NA, Seoul (KR); Hyun-Seong KANG, Gyeonggi-do (KR); Seul-Ki KIM, Gyeonggi-do (KR)

(21) Appl. No.: 13/458,908

(22) Filed: Apr. 27, 2012

(30) Foreign Application Priority Data
Jul. 5, 2011 (KR) 10-2011-0066462

(51) Int. Cl. G02F 1/1335

(52) U.S. Cl. 349/106; 349/192

(57) ABSTRACT

A display substrate includes a first blocking pattern and a color filter pattern. The first blocking pattern defines a plurality of pixel areas on a base substrate. The plurality of pixel areas includes a first pixel area and a second pixel area disposed adjacent to each other along a first direction. The color filter pattern partially overlaps each of the first pixel area and the second pixel area, for providing tolerance against misalignment of the color filter pattern with respect to the first and second pixel areas along the first direction, thereby maintaining the reliability of a display panel that includes the display substrate.

### CROSS-REFERENCE TO RELATED APPLICATION

This application claims priority under 35 U.S.C. §119 to Korean Patent Application No. 2011-66462, filed on Jul. 5, 2011 in the Korean Intellectual Property Office (KIPO), the contents of which are herein incorporated by reference in their entirety.

### BACKGROUND OF THE INVENTION

1. Field of the Invention

Example embodiments of the present invention relate to a display substrate and a method of repairing the display substrate. More particularly, example embodiments of the present invention relate to a display substrate having a high light transmission rate and a method of repairing the display substrate.

2. Description of the Related Art

Generally, a display apparatus includes a display panel, a backlight assembly, and a receiving container. The display panel includes a first display substrate and a second display substrate, and the backlight assembly includes an internal light source. The display panel transmits light provided from the light source to display an image.

Recently, a transparent display apparatus displaying an image using an external light source such as natural or artificial light has been used; the transparent display apparatus may not have a backlight assembly that includes an internal light source. If a full-cover color filter entirely covering a pixel transmitting the light is used in the transparent display apparatus, the transparent display apparatus may be ineffective for transparently displaying the image.

Therefore, in the display panel of the transparent display apparatus, a partial-cover color filter partially covering the pixel is used, so that the transparent display apparatus may transparently display the image in a more effective manner.

Typically, the partial-cover color filter may be misaligned with respect to the pixel in a longitudinal direction of the pixel, so that a transmission rate is increased and a color reproducibility is decreased, or the transmission rate is decreased and the color reproducibility is increased. For example, when the partial-cover color filter is misaligned with respect to the pixel to increase an area covered by the partial-cover color filter, the transmission rate may be decreased and the color reproducibility may be increased. On the other hand, when the partial-cover color filter is misaligned with respect to the pixel to decrease the area covered by the partial-cover color filter, the transmission rate may be increased and the color reproducibility may be decreased. Thus, the transmission rate and the color reproducibility may be variable, unstable, and inconsistent.

### SUMMARY OF THE INVENTION

Example embodiments of the present invention provide a display substrate having a substantially constant transmission rate and a substantially constant color reproducibility, the display substrate being capable of partially repairing a pixel.

Example embodiments of the present invention also provide a method of repairing the display substrate.

According to an example embodiment of the present invention, a display substrate includes a first blocking pattern and a first color filter pattern. The first blocking pattern defines a plurality of pixel areas on a base substrate, the plurality of pixel areas including a first pixel area and a second pixel area disposed adjacent to each other along a first direction. The color filter pattern partially overlaps each of the first pixel area and the second pixel area along the first direction.

In an example embodiment, each of the pixel areas may include a first portion, a second portion and a third portion disposed in order along the first direction. The first color filter pattern may overlap the third portion of the first pixel area, the first portion of the second pixel area, and a portion of the first blocking pattern between the third portion of the first pixel area and the first portion of the second pixel area. The first direction may be a longitudinal direction of at least the first pixel area.

In an example embodiment, the display substrate may further include a color connecting pattern. The color connecting pattern may be disposed between the first color filter pattern and a second color filter pattern adjacent to in the first color filter pattern along the first direction, The color connecting pattern may connect the first color filter pattern with the second color filter pattern and may overlap the first blocking pattern.

In an example embodiment, the first color filter pattern, the second color filter pattern, and the color connecting pattern may define an opening. The opening may overlap the second portion of the first pixel area. The opening may have a first width along a second direction crossing the first direction; the first width may be larger than a second width of the pixel area.

In an example embodiment, the first color filter pattern, the second color filter pattern, and the color connecting pattern may define an opening. The opening may overlap the second portion of the first pixel area. The opening may have a first width along a second direction crossing the first direction; the first width may be smaller than a second width of the pixel area.

In an example embodiment, the color filter pattern may have a first width along a second direction crossing the first direction; the first width may be larger than a second width of the pixel area.

In an example embodiment, the display substrate may further include a column spacer disposed over the color filter pattern and overlapping the first blocking pattern.

In an example embodiment, the display substrate may further include a second blocking pattern extending from the first blocking pattern and partially overlapping the first pixel area. The second blocking pattern may be thinner than the first blocking pattern.

According to an example embodiment of the present invention, a display substrate includes a first blocking pattern and a first color filter pattern. The first blocking pattern defines a first pixel area that includes a first portion, a second portion and a third portion disposed in order along a first direction on a base substrate. The first color filter pattern overlaps the second portion of the first pixel area, extends in a second direction crossing the first direction, and overlaps a first portion of the first blocking pattern that is adjacent to the second portion.

In an example embodiment, the first color filter pattern may extend in the second direction and may overlap portions of a plurality of pixel areas arranged along the second direction, the portions of the plurality of pixel areas corresponding to the second portion of the first pixel area.

In an example embodiment, the display substrate may further include a color connecting pattern. The color connecting pattern may be disposed between the first color filter pattern and a second color filter pattern adjacent to in the first color filter pattern along the first direction, the color connecting pattern connecting the first color filter pattern with the second color filter pattern and overlapping the first blocking pattern.

In an example embodiment, the first and second color filter patterns and the color connecting patterns disposed between the color filter pattern may define an opening. The opening may overlap the first portion of the first pixel area. The opening may have a first width along the second direction, the first width being larger than a width of the pixel area.

In an example embodiment, the first and second color filter patterns and the color connecting pattern may define an opening. The opening may overlap the first portion of the first pixel area. The opening may have a first width along the second direction, the first width being smaller than a width of the pixel area.

In an example embodiment, the display substrate may further include a column spacer disposed on a second portion of the first blocking pattern that is between the first and second color filter patterns.

In an example embodiment, the display substrate may further include a second blocking pattern extending from the first blocking pattern and overlapping the second portion of the pixel area. The second blocking pattern may be thinner than the first blocking pattern.

According to an example embodiment of the present invention, a display substrate includes a first blocking pattern, a color filter pattern, and a second blocking pattern. The first blocking pattern defines a plurality of pixel areas on a base substrate, the plurality of pixel areas including a first pixel area and a second pixel area. The color filter pattern partially overlaps with the first pixel area. The second blocking pattern extends from the first blocking pattern and partially overlaps the second pixel area. The second blocking pattern may be thinner than the first blocking pattern.

In an example embodiment, the plurality of pixel areas may be arranged along a first direction and along a second direction crossing the first direction, and each pixel of the plurality of pixel areas may include a first portion, a second portion, and a third portion disposed in order along the first direction. The color filter pattern may overlap the first and third portions of the first pixel area. The second blocking pattern may overlap the first and third portions of the second pixel area.

In an example embodiment, the plurality of pixel areas may be arranged along a first direction and along a second direction crossing the first direction, and each pixel may include a first portion, a second portion, and a third portion disposed in order along the first direction. The color filter pattern may overlap the second portion of the first pixel area. The second blocking pattern may overlap the second portions of the second pixel area.

In an example embodiment, the plurality of pixel areas may be arranged along a first direction and along a second direction crossing the first direction, and each pixel may include a first portion and a second portion disposed in order along the first direction. The color filter pattern may overlap one of the first portion and the second portion of the first pixel area. The second blocking pattern may overlap one of the first portion and the second portion of the second pixel area.

In an example embodiment, the second blocking pattern may have a first length along the first direction, and the first length may be smaller than a length of the pixel area. The second blocking pattern may have a first width along the second direction, and the first width may be larger than or equal to width of the pixel area.

According to an example embodiment of the present invention, a method of repairing a display substrate is provided. In the method, a first laser is irradiated to a color filter pattern that partially overlaps a pixel area to remove at least a portion of the color filter pattern, the pixel area being defined by a first blocking pattern on a base substrate. A second laser is irradiated to a portion of the first blocking pattern that is adjacent to the color filter pattern to form a second blocking pattern in at least a portion of the pixel area, the second blocking pattern extending from the first blocking pattern.

In an example embodiment, the pixel area may include a first portion, a second portion, and a third portion in order along the first direction, the second portion being positioned between the first portion and the third portion. The first laser may be irradiated to one or more portions of the color filter pattern that correspond to the first and third portions of the pixel area.

In an example embodiment, the pixel area may include a first portion, a second portion, and a third portion in order along the first direction. The first laser may be irradiated to one or more portions of the color filter pattern that correspond to the second portion of the pixel area.

In an example embodiment, the pixel area may include a first portion and a second portion in order along the first direction. The first laser may be irradiated to one or more portions of the color filter pattern that correspond to one of the first portion and the second portion of the pixel area.

According to an example embodiment of the present invention, a display panel includes a first display substrate and a second display substrate. The first display substrate includes a first blocking pattern defining a plurality of pixel areas on a first base substrate, the plurality of pixel areas including a first pixel area and a second pixel area disposed adjacent to each other along a first direction. The second display substrate includes a second base substrate opposite to the first display substrate, a switching element disposed on the second base substrate and corresponding to the first pixel area, and a color filter pattern disposed on the switching element and partially overlapping each of the first pixel area and the second pixel area.

In an example embodiment, each pixel area of the plurality of pixel areas may include a first portion, a second portion, and a third portion in order along the first direction. The color filter pattern may overlap the third portion of the first pixel area, the first portion of the second pixel area, and a portion of the first blocking pattern that is disposed between the third portion of the first pixel area and the first portion of the second pixel area. The first direction may be a longitudinal direction of the first pixel area.

In an example embodiment, the second display substrate may further include a second blocking pattern extending from the first blocking pattern and partially overlapping the first pixel area.

According to an example embodiment of the present invention, a display panel includes a first display substrate and a second display substrate. The first display substrate includes a first base substrate. The second display substrate includes a second base substrate opposite to the first display substrate, a switching element disposed on the second base substrate, and a first blocking pattern disposed on the switching element and defining a plurality of pixel areas. The plurality of pixel areas may include a first pixel area and a second pixel area adjacent to each other along a first direction. The second display substrate may further include a color filter pattern disposed on the switching element and the first blocking pattern and partially overlapping each of the first pixel area and the second pixel area.

In an example embodiment, the second display substrate may further include a second blocking pattern extending from the first blocking pattern and partially overlapping the second pixel area.

According to the present invention, even if a set of color filter patterns is misaligned with respect to a set of pixel areas, the total area in which the set of color filter patterns overlaps the set of pixel areas may remain substantially constant and substantially consistent. Therefore, a display panel that includes the set of color filter patterns and the set of pixel areas may have improved fault tolerance against misalignment. Advantageously, a transmission rate and a color reproducibility of the display panel may remain substantially constant and/or substantially consistent.

A color filter pattern entirely covers a first blocking pattern between pixel areas adjacent to each other in a longitudinal direction, so that an upper surface of the first blocking pattern may be planarized. Advantageously, the display panel may have a substantially constant liquid crystal margin over the color filter pattern on the first blocking pattern.

In one or more embodiments, the color filter pattern may not cover the portion of the first blocking pattern that is disposed between pixel areas adjacent to each other along the longitudinal direction, so that the upper surface of the first blocking pattern may be planarized. Thus, the display panel may have a substantially constant liquid crystal margin over the first blocking pattern.

The color filter pattern partially overlaps a pixel area. The pixel area may be partially repaired using a nearby blocking pattern.

### BRIEF DESCRIPTION OF THE DRAWINGS

The above and other features and advantages of the present invention will become more apparent by describing in detailed example embodiments thereof with reference to the accompanying drawings, in which:

FIG. 1 is a plan view illustrating a first display substrate according to an example embodiment of the present invention;

FIG. 2 is a cross-sectional view illustrating a display panel including the first display substrate taken along a line I-I′ of FIG. 1;

FIGS. 3A and 3B are partial plan views illustrating the first display substrate for explaining a transmission rate and color production of a color filter pattern of FIG. 1;

FIG. 4 is a plan view illustrating a first display substrate according to an embodiment of the present invention;

FIG. 5 is a cross-sectional view illustrating a display panel including the first display substrate taken along a line II-II′ of FIG. 4;

FIGS. 6A and 6B are partial plan views illustrating the first display substrate to explain a transmission rate and a color production of a color filter pattern of FIG. 4;

FIG. 7 is a plan view illustrating a first display substrate according to an example embodiment of the present invention;

FIG. 8 is a plan view illustrating a first display substrate according to an example embodiment of the present invention;

FIG. 9 is a cross-sectional view illustrating a display panel including the first display substrate taken along a line III-III′ of FIG. 8;

FIG. 10 is a plan view illustrating a first display substrate according to an example embodiment of the present invention;

FIG. 11 is a cross-sectional view illustrating a second display substrate according to an example embodiment of the present invention;

FIG. 12 is a cross-sectional view illustrating a second display substrate according to an example embodiment of the present invention;

FIG. 13 is a cross-sectional view illustrating a second display substrate according to an example embodiment of the present invention;

FIG. 14 is a cross-sectional view illustrating a second display substrate according to an example embodiment of the present invention;

FIG. 15 is a plan view illustrating a first display substrate according to an example embodiment of the present invention;

FIG. 16 is a cross-sectional view illustrating a display panel including the first display substrate taken along a line IV-IV′ of FIG. 15;

FIGS. 17A and 17B are cross-sectional views illustrating a method of repairing a first pixel area of the first display substrate of FIG. 15;

FIG. 18 is a plan view illustrating a first display substrate according to an example embodiment of the present invention;

FIG. 19 is a cross-sectional view illustrating a display panel including the first display substrate taken along a line V-V′ of FIG. 18;

FIG. 20 is a plan view illustrating a first display substrate according to an example embodiment of the present invention;

FIG. 21 is a cross-sectional view illustrating a display panel including the first display substrate taken along a line VI-VI′ of FIG. 20;

FIG. 22 is a plan view illustrating a first display substrate according to an example embodiment of the present invention;

FIG. 23 is a plan view illustrating a first display substrate according to an example embodiment of the present invention;

FIG. 24 is a cross-sectional view illustrating a display panel including the first display substrate taken along a line VII-VII′ of FIG. 23;

FIG. 25 is a cross-sectional view illustrating a second display substrate according to an example embodiment of the present invention; and

FIG. 26 is a cross-sectional view illustrating a second display substrate according to an example embodiment of the present invention.

### DETAILED DESCRIPTION OF THE INVENTION

Hereinafter, the present invention will be explained in detail with reference to the accompanying drawings.

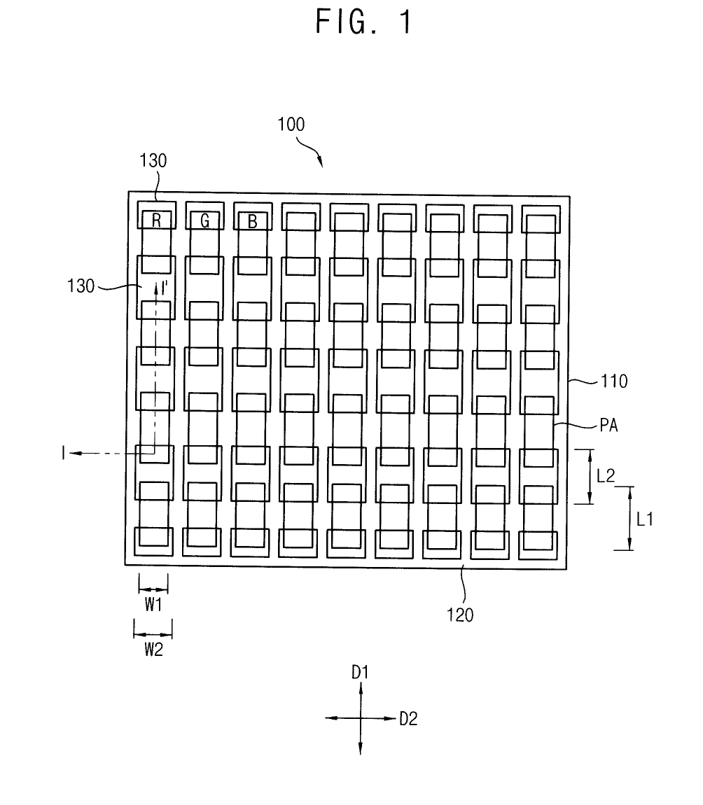

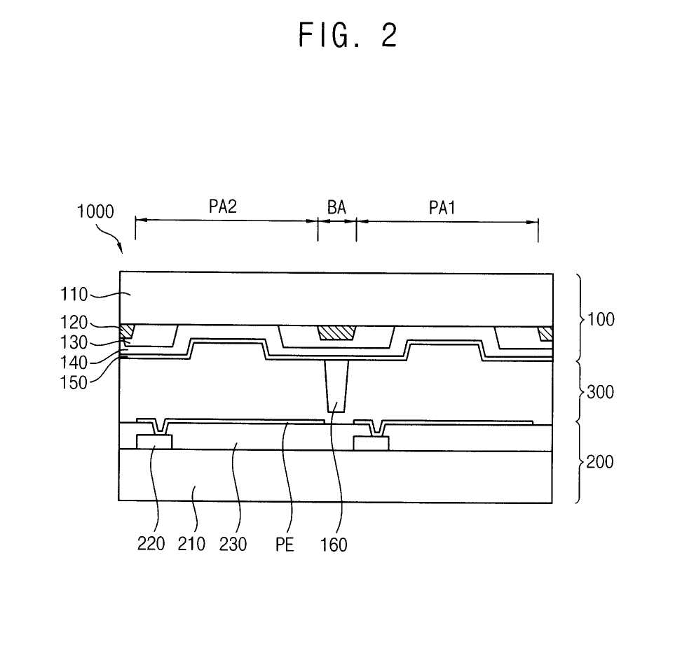

FIG. 1 is a plan view illustrating a first display substrate according to an example embodiment of the present invention. FIG. 2 is a cross-sectional view illustrating a display panel including the first display substrate taken along a line I-I′ of FIG. 1.

Referring to FIG. 1 to FIG. 2, a display panel 1000 includes a first display substrate 100, a second display substrate 200 facing the first display substrate 100, and a liquid crystal layer 300 disposed between the first display substrate 100 and the second display substrate 200. The display panel 1000 may be divided into a plurality of pixel areas PAs (including a pixel area PA1 and a pixel area PA2) and a blocking area BA defining (and positioned between) the pixel areas PAs. External light, including at least one of natural light and artificial light, may be transmitted through the pixel areas PAs of the display panel 1000, and the external light may be blocked by the blocking area BA of the display panel 1000.

The first display substrate 100 includes a first base substrate 110, a first blocking pattern 120, and a color filter pattern 130.

The first blocking pattern 120 is disposed in the blocking area BA on the first base substrate 110. Thus, the first blocking pattern 120 may define (and may be disposed between) the plurality of pixel areas PAs on the first base substrate 110. A pixel area PA is surrounded by the blocking area BA and may have a particular shape. For example, the pixel area PA may have a quadrilateral shape having a chamfered corner. The first blocking pattern 120 may include an organic material having a black color or a gray color.

As an example, the pixel area PA may have a rectangular shape in the plan view of the first display substrate 100. The pixel area PA may have the rectangular shape extending in a first direction D1 and extending in a second direction D2 crossing the first direction D1. The second direction D2 is substantially perpendicular to the first direction D1. The pixel area PA may have a first length L1 extending in the first direction D1 and a first width W1 extending in the second direction D2. The first direction D1 is a longitudinal direction of the pixel area PA, and the second direction D2 is a latitudinal direction of the pixel area PA. The first length L1 may be about three times larger than the first width W1 or about three times the first width W1. The pixel areas PAs may be spaced apart from each other by the blocking area BA and may be arranged in a matrix.

The first blocking pattern 120 blocks the external light transmitted through the first base substrate 110 between pixel areas PAs adjacent to each other, so that the light transmitted through the pixel areas PAs may not interfere with each other.

The color filter pattern 130 may be one of a red color filter pattern R, a green color filter pattern G, and a blue color filter pattern B. The color filter pattern 130 may include an organic material having one of a red color, a green color and a blue color. The red, green and blue color filter patterns R, G and B are alternately arranged. The red color filter pattern R converts the external light into red color light, the green color filter pattern G converts the external light into green color light, and the blue color filter pattern B converts the external light into blue color light.

The color filter pattern 130 has a rectangular shape in the plan view of the first display substrate 100. The color filter pattern 130 may have the rectangular shape extending in the first direction D1 and extending in the second direction D2. The color filter pattern 130 may have a second length L2 extending in the first direction D1 and a second width W2 extending in the second direction D2. The color filter pattern 130 overlaps the pixel area PA in the first direction D1, so that an overlapping area between the color filter pattern 130 and the pixel area PA is defined. If the first length L1 remains constant, as the second length L2 increases, the color reproducibility may increase. On the other hand, as the second length L2 decreases, the light transmission rate may increase. The second width W2 is larger than the first width W1, so that the color filter pattern 130 may have at least one of a left overlay margin and a right overlay margin in the second direction D2.

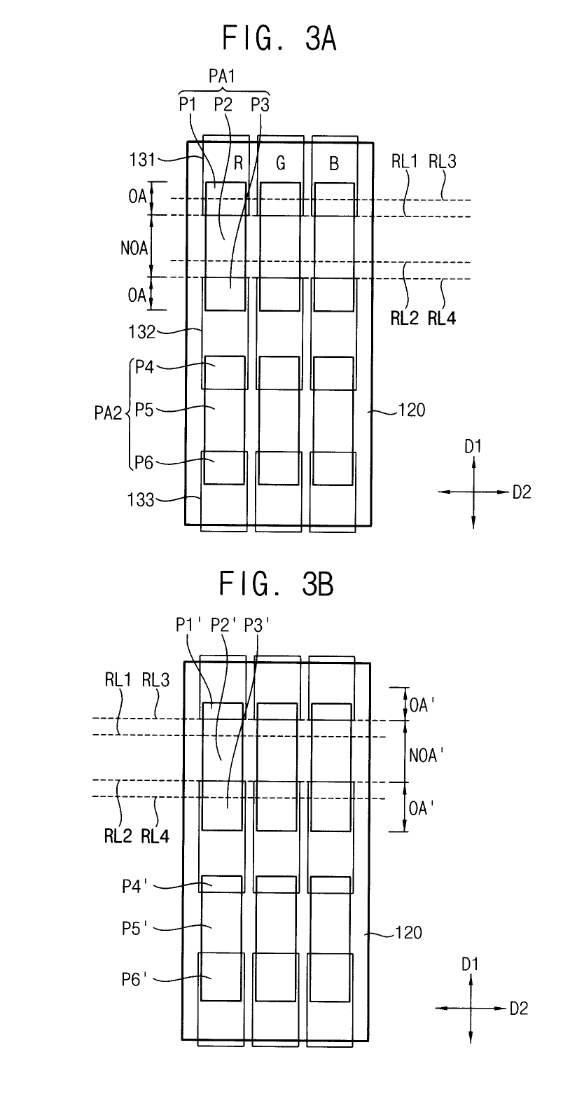

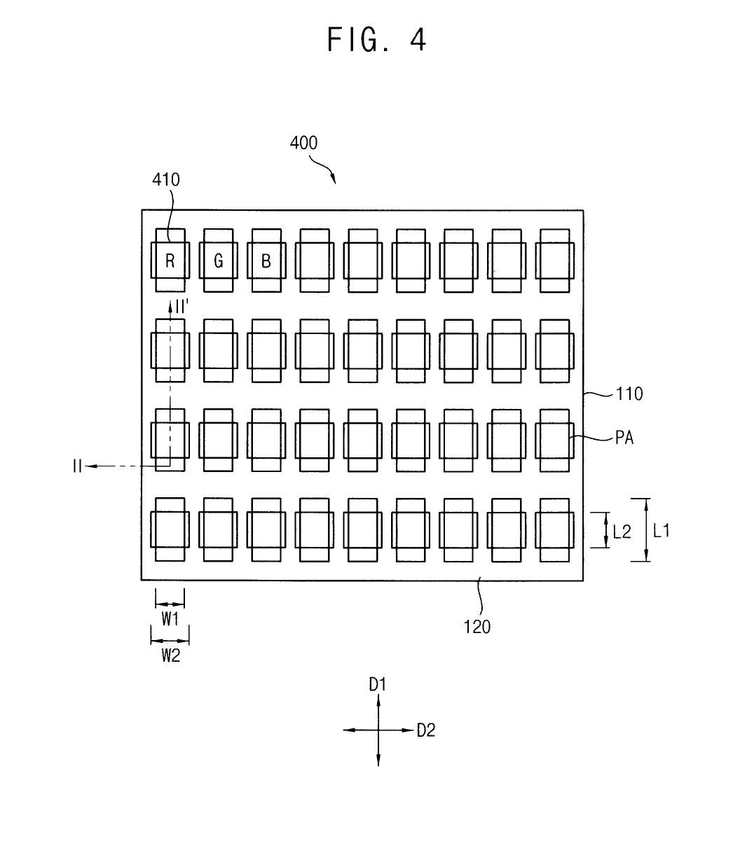

FIGS. 3A and 3B are partial plan views illustrating the first display substrate for explaining the transmission rate and color production of a color filter pattern of FIG. 1.

Referring to FIG. 3A and FIG. 3B, a color filter pattern partially overlaps each of two pixel areas PAs adjacent to each other along the first direction D1.

For example, the first display substrate 100 includes first and second pixel areas PA1 and PA2 that are arranged along the first direction D1 and disposed adjacent to each other. The first display 100 further includes first, second and third color filter patters 131, 132, and 133 that are arranged along the first direction D1 and disposed adjacent to each other. The first pixel area PA1 may include a first portion P1, a second portion P2, and a third portion P3 disposed in order along the first direction D1. The second pixel area PA2 may include a fourth portion P4, a fifth portion P5, and a sixth portion P6 disposed in order along the first direction D1.

The first color filter pattern 131 extends in the first direction D1 and overlaps the first portion P1 of the first pixel area PA1.

The second color filter patter 132 is spaced apart from the first color filter pattern 131 along the first direction D1. The second color filter pattern 132 partially overlaps each of the first and second pixel areas PA1 and PA2 that are adjacent to each other. The second color filter pattern 132 extends from the third portion P3 associated with the first pixel area PA1 to the fourth portion P4 associated with the second pixel area PA2. Thus, the second color filter patter 132 overlaps the third portion P3 associated with the first pixel area PA1, the fourth portion P4 associated with the second pixel area PA2, and the first blocking pattern 120 disposed between the first pixel area PA1 and the second pixel area PA2.

The third color filter patter 133 is spaced apart from the second color filter pattern 132. The third color filter pattern 133 overlaps the sixth portion P6 associated with the second pixel area PA2.

When the first to the third color filter patterns 131, 132, and 133 are formed, the first to the third color filter patterns 131, 132, and 133 may be aligned or misaligned with respect to the pixel areas PA1 and PA2 along the first direction D1. According to an example embodiment, although the first to the third color filter patterns 131, 132, and 133 may move in the first direction D1 to be misaligned with respect to the first and second pixel areas PA1 and PA2, the sum (or total size) of overlapping areas OAs in which the first to the third color filter patterns 131, 132, and 133 overlap the first and the second pixel areas PA1 and PA2 may remain substantially constant and/or substantially consistent for different pixel areas.

For example, when the first to the third color filter patterns 131, 132, and 133 are aligned with (e.g., disposed symmetrically with respect to) the pixel areas PA1 and PA2 along the first direction D1, wherein “aligned” means that the color filter patterns are positioned with respect to the pixel areas according to a predefined configuration of the first display substrate, the first color filter pattern 131 may overlap the first pixel area PA1 at the first portion P1 defined by an upper side of the first pixel PA1 and a first (imaginary) reference line RL1 (which is aligned with a lower edge of the first color filter pattern 131), and the second color filter pattern 132 may overlap the first pixel area PA1 at the third portion P3 defined by a lower side of the first pixel PA1 and a second (imaginary) reference line RL2 (which is aligned with an upper edge of the second color filter pattern 132 and is spaced apart from the first reference lien RL1 by the second portion P2). Thus, the first portion P1 and the third portion P3 display color light as overlapping areas OAs to increase color reproducibility, and the second portion P2 displays white light as a non-overlapping area NOA to increase the light transmission rate. Since the color filters 131 and 132 are disposed symmetrically with respect to the first pixel PA1, the overlapping areas OAs may have the same size. The arrangements of portions P4, P5, and P6 are similar to the arrangements of portions P1, P2, and P3, respectively.

On the other hand, when the first to the third color filter patterns 131, 132, and 133 are misaligned with (e.g., disposed asymmetrically with respect to) the pixel areas PA1 and PA2 along the first direction D1, the first color filter pattern 131 may overlap the first pixel area PA1 at another first portion P1′ defined by at least the upper side of the first pixel PA1 and a third (imaginary) reference line RL3 moved from the first reference line RL1 in the first direction D1, and the second color filter pattern 132 may overlap the first pixel area PA1 by another third portion P3′ defined by at least the lower side of the first pixel PA1 and a fourth (imaginary) reference line RL4 moved from the second reference line RL2 in the first direction D1. Thus, the first portion P1′ and the third portion P3′ display the color light as another set of overlapping areas OA's to increase color reproducibility, and the second portion P2′ displays the white light as another non-overlapping area NOA′ to increase the light transmission rate. Since the color filters 131 and 132 are disposed asymmetrically with respect to the first pixel PA1, the overlapping areas OA's may have different sizes. The arrangements of portions P4′, P5′, and P6′ are similar to the arrangements of portions P1′, P2′, and P3′, respectively.

The first to the third color filter patterns 131, 132, and 133 simultaneously move in the first direction D1, so that a total area of the overlapping areas OAs defined by the first and the second reference line RL1 and RL2 is substantially equal to a total area of the overlapping areas OAs' defined by the third and the fourth reference lines RL3 and RL4.

Referring to FIG. 1 and FIG. 2, the first display substrate 100 may further include an over-coating layer 140, a common electrode layer 150, and a column spacer 160. The over-coating layer 140 may be an organic layer. The column spacer 160 is disposed over the color filter pattern 130 and overlapping the first blocking pattern 120. The color filter pattern 130 is formed to completely cover the first blocking pattern 120 between two pixel areas PAs adjacent to each other in the first direction D1. The color filter pattern 130 may be relatively planarized on the first blocking pattern 120. Thus, the display panel 1000 may have a substantially constant liquid crystal margin at or near the position of the column spacer 160 over the color filter pattern 130 overlapping the first blocking pattern 120.

Alternatively or additionally, the column spacer 160 may be included in the second display substrate 200.

The second display substrate 200 includes a second base substrate 210, a switching element 220, a protecting layer 230, and a pixel electrode P3. The switching element 220 and the pixel electrode PE are formed in the pixel area PA (e.g., PA1 or PA2). The switching element 220 includes a gate electrode, a source electrode, and a drain electrode, and the pixel electrode PE is electrically connected to the drain electrode of the switching element 220. The protecting layer 230 may be an organic layer or an inorganic layer.

According to the examples of FIGS. 1-3B, although the first to the third color filter patterns 131, 132, and 133 may be aligned or misaligned with (e.g., disposed asymmetrically with respect to) the pixel areas PA1 and PA2 along the first direction D1, the color reproducibility and the transmission rate of the display panel 1000 including the first display substrate 100 may remain substantially constant and/or substantially consistent for different pixel areas.

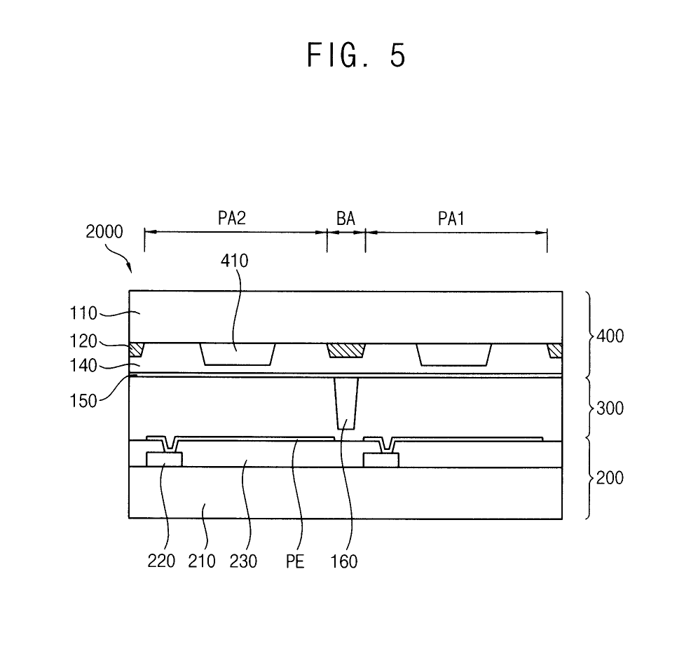

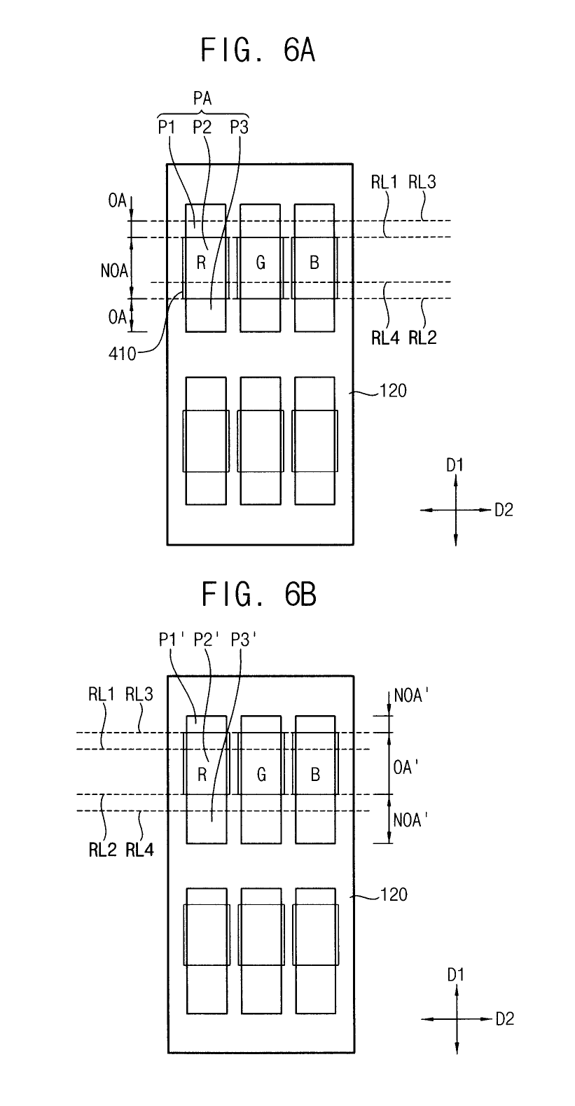

FIG. 4 is a plan view illustrating a first display substrate according to an example embodiment of the present invention. FIG. 5 is a cross-sectional view illustrating a display panel including the first display substrate taken along a line II-II′ of FIG. 4. FIGS. 6A and 6B are partial plan views illustrating the first display substrate to explain a transmission rate and a color production of a color filter pattern of FIG. 4.

A first display substrate according to the present example embodiment may be substantially similar to or the same as the first display substrate according to the examples of FIG. 1 to FIG. 3B except, for example, relationships between color filter patterns and pixel areas; thus the same reference numerals will be used to refer to the same or like parts as those described in the examples of FIG. 1 to FIG. 3B, and repetitive explanation concerning the above elements may be omitted.

Referring to FIG. 4 to FIG. 6B, a first display substrate 400 of a display panel 2000 includes a first base substrate 110, a first blocking pattern 120, and a color filter pattern 410.

The color filter pattern 410 partially overlaps the pixel area PA. In particular, the color filter pattern 410 overlaps a portion of the pixel area PA without completely covering the pixel area PA. For example, the pixel area PA may be divided into a first portion P1, a second portion P2 and a third portion P3 in order. The color filter pattern 410 overlaps the second portion P2 without overlapping the first portion P1 or the third portion P3.

When the color filter patterns 410 are formed, the color filter patterns 410 may be aligned or misaligned with (e.g., disposed symmetrically or asymmetrically with respect to) the pixel areas PAs. According to one or more embodiments, although the color filter pattern 410 may move with respect to the corresponding pixel area PA in the first direction D1, the size of an overlapping area OA (defined by upper and lower edges of the color pattern 410 and left and right sides of the pixel area PA) in which the color filter pattern 410 and the corresponding pixel area PA overlap each other may remain constant.

For example, when the color filter patterns 410 is aligned with (e.g., disposed symmetrically with respect to) the pixel area PA along the first direction D1, the color filter pattern 410 may overlap with the pixel area PA at the second portion P2 between a first reference line RL1 and a second reference line RL2. Thus, the second portion P2 displays color light as the overlapping area OA to increase the color reproducibility, and the first portion P1 and the third portion P3 display white light as two non-overlapping areas NOAs to increase the transmission rate. The overlapping area OA (or the second portion P2) is defined by the upper and lower edges of the color filter pattern 410 and the left and right sides of the pixel area PA. Since the color filter 410 is disposed symmetrically with respect to the pixel PA, the two non-overlapping areas NOAs (or portions P1 and P3) may have the same size.

On the other hand, when the color filter patterns 410 is misaligned with (e.g., disposed asymmetrically with respect to) the pixel area PA along the first direction D1, the color filter pattern 410 may overlap the pixel area PA at another second portion P2′ between a third reference line RL3 moved from the first reference line RL1 in the first direction D1 and a fourth reference line RL4 moved from the second reference line RL2 in the first direction D1. Thus, the second portion P2′ displays the color light as the overlapping area OA′ to increase the color reproducibility, and the first portion P1′ and the third potion P3′ display the white light as two non-overlapping area NOA's to increase the transmission rate. The overlapping area OA′ (or the second portion P2′) is defined by the upper and lower edges of the color filter pattern 410 and the left and right sides of the pixel area PA. Since the color filter 410 is disposed asymmetrically with respect to the pixel PA, the two non-overlapping areas NOA's (or portions P1′ and P3′) may have different sizes. As illustrated in the example of FIG. 6B, the first portion P1′ is smaller than the third portion P3′.

Although the color filter pattern 410 moves in the first direction D1, the area (or size) of the overlapping area OA according to the first and the second reference lines RL1 and RL2 is substantially the same as the area (or size) of the overlapping area OA′ according to the third and the fourth reference lines RL3 and RL4, wherein the upper and lower edges of the color filter pattern 410 remain between the upper and lower sides of the pixel area PA

As illustrated in the example of FIG. 5, the first display substrate 100 may further include an over-coating layer 140, a common electrode layer 150, and a column spacer 160. The column spacer 160 is disposed over the first blocking pattern 120. The color filter pattern 410 is not formed on the first blocking pattern 120, so that the column spacer 160 may be directly formed on the first blocking pattern 120, and so that the color filter pattern is not disposed between the column spacer 160 and the first blocking pattern 120. Thus, the display panel 2000 may have a substantially constant liquid crystal margin at or near the column spacer 160.

According to the examples of FIGS. 4-6B, although the color filter patterns 410 may be aligned or misaligned with (e.g., disposed asymmetrically with respect to) the pixel area PA along the first direction D1, the color reproducibility and the transmission rate of the display panel 2000 including the first display substrate 400 may remain substantially constant and/or substantially consistent for different pixel areas.

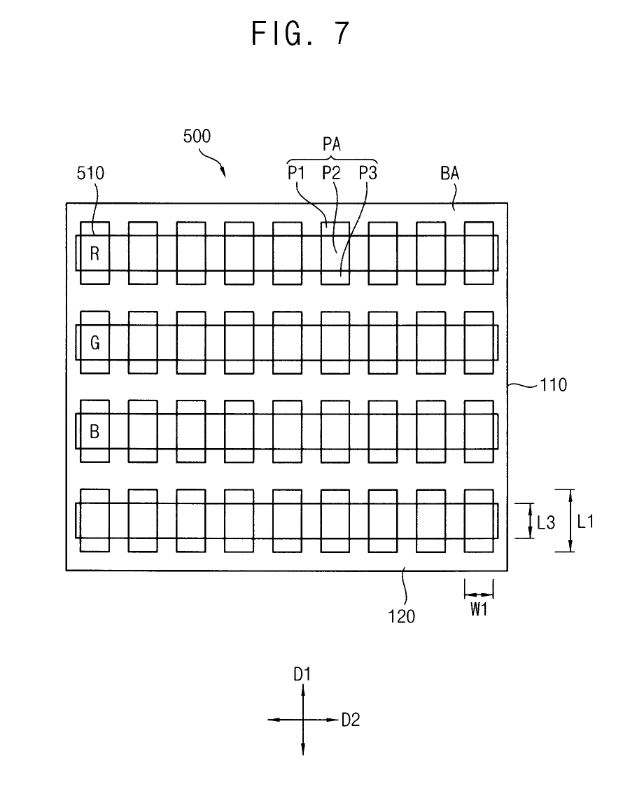

FIG. 7 is a plan view illustrating a first display substrate according to an example embodiment of the present invention.

A first display substrate according to the present example embodiment is substantially the same as the first display substrate according to the examples of FIG. 4 to FIG. 6B except, for example, the shapes of the color filter patterns; thus the same reference numerals will be used to refer to the same or like parts as those described in the examples of FIG. 4 to FIG. 6B, and repetitive explanation concerning the above elements may be omitted.

Referring to FIG. 7, a first display substrate 500 includes a first base substrate 110, a first blocking pattern 120, and a color filter pattern 510.

A pixel area PA defined by the first blocking pattern 120 may have a rectangular shape. The pixel area PA may have the rectangular shape extending in first direction D1 and a second direction crossing the first direction D1. The pixel area PA may have a first length L1 extending in the first direction D1 and a first width W1 extending in the second direction D2. The first length L1 may be about three times the first width W1. The pixel areas PA may be spaced apart from each other by the blocking area BA, and arranged in a matrix shape.

The color filter pattern 510 may have a stripe shape extending in the first direction D1 and the second direction D2. The color filter pattern 510 may have a third length L3 extending in the first direction D1. The third length L3 is smaller than the first length L1. As the third length L3 increases, the color reproducibility may increase, and as the third length L3 decreases, the transmission rate may increase.

The color filter pattern 510 partially overlaps each of the pixel areas PAs adjacent to each other along the second direction D2. In other words, the color filter pattern overlaps a portion of each pixel area PA of a plurality of pixel areas PAs without completely covering the pixel area PA, wherein the plurality of pixel areas PAs is disposed along the second direction D2.

For example, the pixel area PA may be divided into a first portion P1, a second portion P2 and a third portion P3 disposed in order in the first direction D1. The color filter pattern 510 overlaps the second portion P2 of each of the plurality of the pixel areas PAs indisposed along the second direction D2. The second portions P2s are defined by the upper and lower edges of the color filter pattern 510 and the left and right sides of the pixel areas PAs.

When the color filter patterns 510 are formed, the color filter patterns 510 may be aligned or misaligned with (e.g., disposed symmetrically or asymmetrically with respect to) the pixel areas PAs. According to the example embodiment of FIG. 7, although the color filter pattern 510 may be misaligned (or disposed asymmetrically) with respect to the corresponding pixel areas PAs along the first direction D1, the total size of overlapping areas OAs in which the color filter pattern 510 and the corresponding pixel areas PAs overlap may remain substantially constant and/or substantially consistent for different pixel areas, wherein the upper and lower edges of the color filter pattern 510 remain between the upper and lower sides of the pixel areas PAs.

The overlapping areas OA according to the present example embodiment are substantially the same as those according to the example embodiment of FIG. 4, so that any repetitive explanation concerning the above elements will be omitted.

According to the present example embodiment of FIG. 7, although the color filter patterns 510 may be misaligned with (e.g., disposed symmetrically or asymmetrically with respect to) the pixel areas PAs along the first direction D1, the color reproducibility and the transmission rate of the first display substrate 500 may remain substantially constant and/or substantially consistent for different pixel areas.

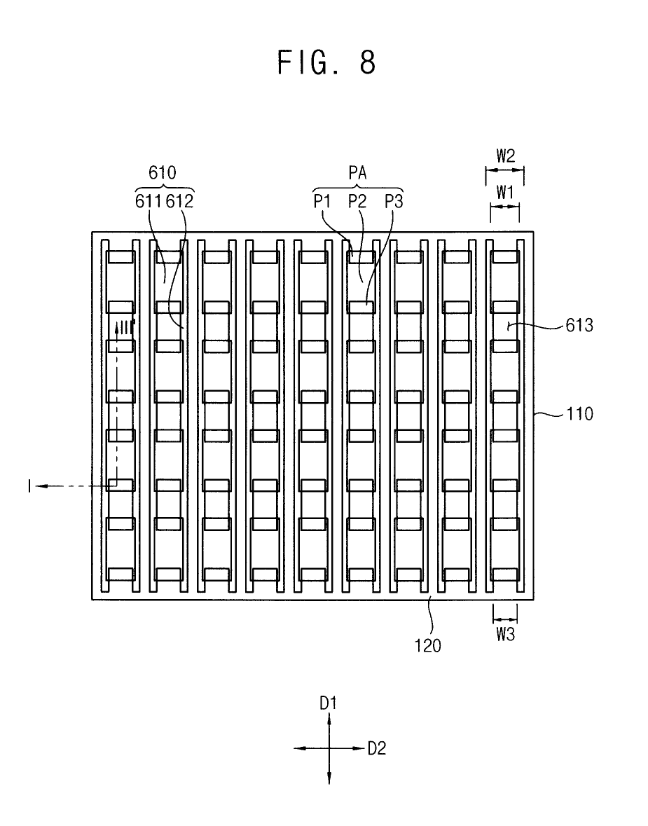

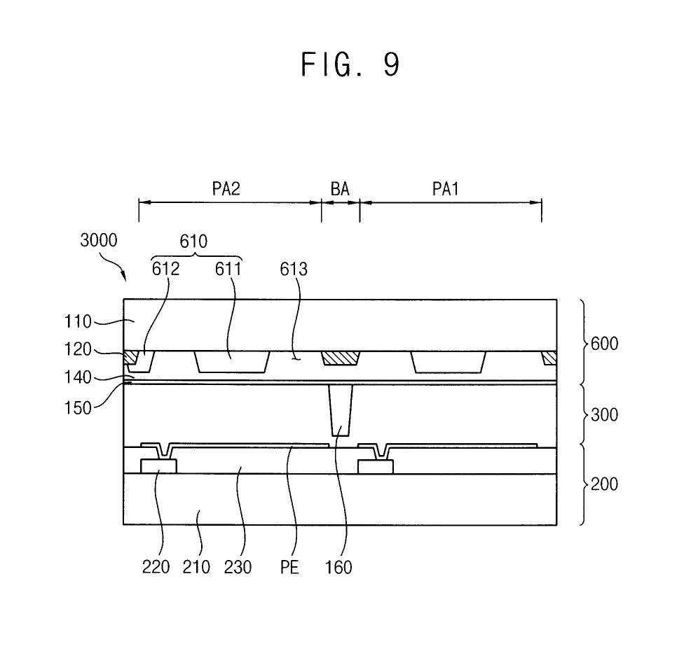

FIG. 8 is a plan view illustrating a first display substrate according to an example embodiment of the present invention. FIG. 9 is a cross-sectional view illustrating a display panel including the first display substrate taken along a line III-III′ of FIG. 8.

A first display substrate according to the present example embodiment is substantially the same as the first display substrate according to the examples of FIG. 1 to FIG. 6B except, for example, a color pattern including a color filter pattern; thus the same reference numerals will be used to refer to the same or like parts as those described in the examples of FIG. 1 to FIG. 6B, and repetitive explanation concerning the above elements may be omitted.

Referring to FIG. 8 and FIG. 9, a first display substrate 600 of a display panel 3000 includes a first base substrate 110, a first blocking pattern 120, and a color pattern 610.

The color pattern 610 extends in the first direction D1. The color pattern 610 may have a second width W2 extending in the second direction D2. The second width W2 is larger than the first width W1 associated with the pixel area PA, so that the color pattern 610 may have a left overlay margin and a right overlay margin disposed along the second direction D2. The color pattern 610 includes a color filter pattern 611 and a color connecting pattern 612.

The color filter pattern 611 may have a rectangular shape. The color filter pattern 611 may have the rectangular shape extending in the first direction D1 and the second direction D2. Analogous to the color filter pattern 410 illustrated in the example of FIG. 4, the color filter pattern 611 also may have a second length L2 extending in the first direction D1 and the second width W2.

The color connecting pattern 612 is disposed between color filter patterns 611 adjacent to each other along the first direction D1, and connects the color filter patterns 611 adjacent to each other. The color connecting pattern 612 extends in the first direction D1, and corresponds to a boundary between the blocking area BA of the first blocking pattern 120 and the pixel area PA.

The color filter patterns 611 adjacent to each other and the color connecting patterns 612 disposed between the color filter patterns 611 adjacent to each other may define an opening 613. The opening 613 may have a third width W3 smaller than the first width W1. Thus, the opening 613 may be disposed between the overlay margins of the color pattern 610 overlapping the pixel area PA and disposed along the second direction D2. Alternatively, the opening 613 may have a fourth width larger than the first width W1.

The color pattern 610 partially overlaps each of the pixel areas PAs adjacent to each other along the first direction D1 without overlapping the pixel areas PAs at the openings 613.

For example, the pixel area PA may be divided into a first portion P1, a second portion P2, and a third portion P3 disposed in order along the first direction D1. The color filter pattern 611 overlaps with the second portion P2 defined by the upper and lower edges of the color filter pattern 611 and the left and right sides of the pixel area PA. The color connecting pattern 612 partially overlaps each of the third portion P3 of the pixel area PA (defined by the lower edge of a color filter pattern 611 and the lower, left, and right sides of the pixel area PA) and the first portion P1 of a second pixel area PA (defined by the upper edge of another color filter pattern 611 and the upper, left, and right sides of the second pixel area PA) adjacent to the pixel area PA along the first direction D1. The opening 613 overlaps the third portion P3 of the pixel area PA and the first portion P1 of the second pixel area PA adjacent to the pixel area PA along the first direction D1.

When the color pattern 610 is formed, the color pattern 610 may be aligned or misaligned with (e.g., disposed symmetrically or asymmetrically with respect to) the pixel areas PAs along the first direction D1. According to the example embodiment of FIG. 8, although the color pattern 610 may be misaligned (or disposed asymmetrically) with respect to the pixel areas PAs along the first direction D1, the size of an overlapping area OA in which the color pattern 610 and one pixel area PA overlap each other may remain constant.

The overlapping areas OAs according to the present example embodiment are substantially the same as those according to the previous example embodiment of FIG. 4, so that repetitive explanation concerning the above elements may be omitted.

According to the present example embodiment of FIG. 8, although the color filter patterns 611 may be misaligned (or disposed asymmetrically) with respect to the pixel areas PAs along the first direction D1, the color reproducibility and the transmission rate of the display panel of the first display substrate 600 may remain substantially constant and/or substantially consistent for different pixel areas.

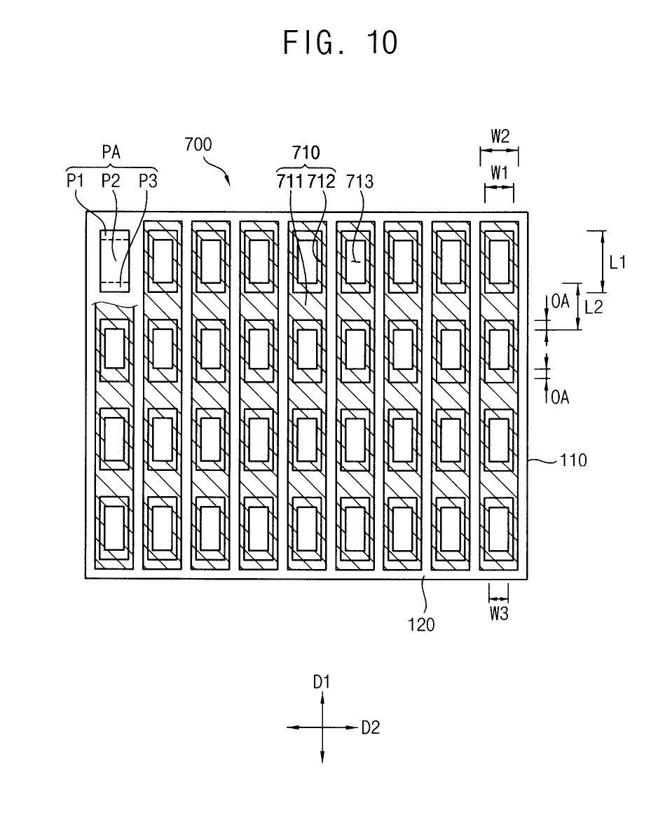

FIG. 10 is a plan view illustrating a first display substrate according to an example embodiment of the present invention.

A first display substrate according to the present example embodiment is substantially the same as the first display substrate according to the examples of FIG. 1 to FIG. 3B except, for example, a shape of a color filter pattern; thus the same reference numerals will be used to refer to the same or like parts as those described in the examples of FIG. 1 to FIG. 3B, and repetitive explanation concerning the above elements may be omitted.

Referring to FIG. 10, a first display substrate 700 includes a first base substrate 110, a first blocking pattern 120 and a color pattern 710.

The color pattern 710 extends in a first direction D1. The color pattern 710 may have a second width W2 extending in a second direction D2 crossing the first direction D1. The second width W2 is larger than a first width W1 of a pixel area PA. Thus, the color pattern 710 may have a left overlay margin and a right overlay margin overlapping the pixel area PA and disposed along the second direction D2. The color pattern 710 includes a color filter pattern 711 and a color connecting pattern 712.

The color filter pattern 711 has a rectangular shape. The color filter pattern 711 may have the rectangular shape extending in the first direction D1 and extending in the second direction D2. The color filter pattern 711 may have a second length L2 extending in the first direction D1 and the second width W2.

The color connecting pattern 712 is disposed between the color filter patterns 711 adjacent to each other along the first direction D1, and connects the color filter patterns 711 adjacent to each other. The color connecting pattern 712 extends in the first direction D1, and corresponds to a boundary between a blocking area BA of the first blocking pattern 120 and the pixel area PA.

The color filter patterns 711 adjacent to each other and the color connecting patterns 712 disposed between the color filter patterns 711 adjacent to each other may define an opening 713. The opening 713 may have a third width W3 smaller than the first width W1. Thus, the opening 713 may be disposed between the left and right overlay margins of the color pattern 710 overlapping the pixel area PA and disposed along the second direction D2. Alternatively, the opening 713 may have a fourth width larger than the first width W1.

The color pattern 710 partially overlaps with each pixel area PA of the pixel areas PAs adjacent to each other along the first direction D1 without completely covering the pixel area PA. One color filter pattern 711 partially overlaps with each of two pixel areas PA adjacent to each other along the first direction D1.

For example, the pixel area PA may be divided into a first portion P1 (defined by the lower edge of a first color filter pattern 711 and the upper, left, and right sides of the pixel area PA), a second portion P2 (defined by the lower edge of the first color filter pattern 711, the upper edge of a second color filter pattern 711, and the left and right sides of the pixel area PA), and a third portion P3 (defined by the upper edge of the second color filter pattern 711 and the lower, left, and right sides of the pixel area PA) disposed in order along the first direction D1. The color filter pattern 711 overlaps the third portion P3 of one pixel area PA and the first portion P1 of another pixel area PA adjacent to the pixel area PA along the first direction D1. The color connecting pattern 712 partially overlaps each of the second portion P2 of the pixel area PA and the second portion P2 of another pixel area PA adjacent to the pixel area PA along the first direction D1. The opening 713 overlaps with each of the second portion P2 of the pixel area PA and the second portion P2 of another pixel area PA adjacent to the pixel area PA along the first direction D1. The color pattern 710 overlaps the pixel areas PAs at overlapping areas where the color filter patterns 711 and the color connecting patterns 712 overlap the pixel areas. Each of the overlapping areas surrounds a non-overlapping area that corresponds to an opening 713 of the color pattern 710.

When the color pattern 710 is formed, the color pattern 710 may be aligned or misaligned with (e.g., disposed symmetrically or asymmetrically with respect to) the pixel areas PAs along the first direction D1. According to the t example embodiment of FIG. 10, although the color pattern 710 may be misaligned (or disposed asymmetrically) with respect to the pixel areas PA along the first direction D1, the size of an overlapping area OA in which the color pattern 710 and one pixel area PA overlap each other may remain substantially constant and/or substantially consistent for different pixel areas, wherein the upper and lower edges of the opening 713 remain between the upper and lower sides of the pixel area PA.

The overlapping areas OA according to the present example embodiment are substantially the same as those according to the example embodiment of FIG. 1 except, for example, the additional overlapping areas contributed by the color connecting pattern 712; repetitive explanation concerning the above elements may be omitted.

According to the example embodiment of FIG. 10, although the color filter patterns 710 may be misaligned (or disposed asymmetrically) with respect to the pixel areas PA along the first direction D1, the color reproducibility and the transmission rate of the display panel of the first display substrate 700 may remain substantially constant and/or substantially consistent for different pixel areas.

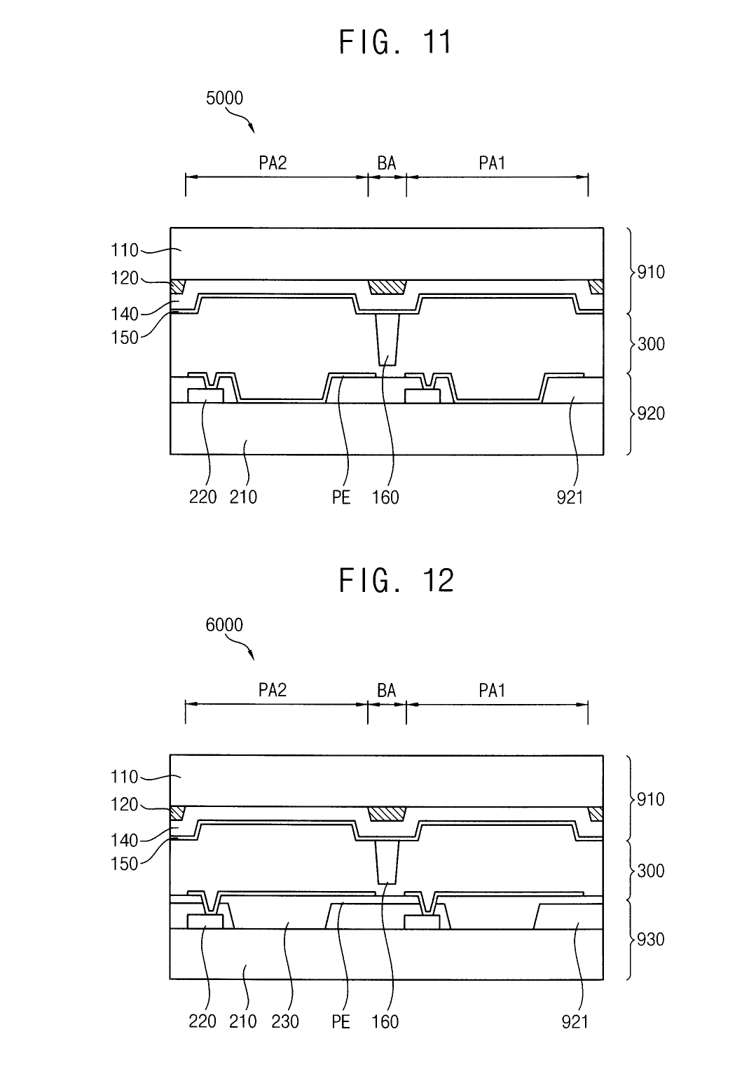

FIG. 11 is a cross-sectional view illustrating a second display substrate according to an example embodiment of the present invention.

A second display substrate according to the present example embodiment is substantially the same as the second display substrate according to the example embodiment of FIG. 2 except, for example, color filter patterns and a protecting layer; thus the same reference numerals will be used to refer to the same or like parts as those described in the example embodiment of FIG. 2, and repetitive explanation concerning the above elements may be omitted.

Referring to FIG. 11, a display panel 5000 includes a first display substrate 910, a second display substrate 920 facing the first substrate 910, and a liquid crystal layer 300 disposed between the first display substrate 910 and the second display substrate 920.

The first display substrate 910 includes a first base substrate 110 and a first blocking pattern 120. The first display substrate 910 may further include an over-coating layer 140, a common electrode layer 150, and a column spacer 150.

The second display substrate 920 includes a second base substrate 210, a switching element 220, a color filter pattern 921, and a pixel electrode PE. The switching element 220 and the pixel electrode PE are formed in the pixel area PA. The switching element 220 includes a gate electrode, a source electrode and a drain electrode.

A color filter pattern 921 according to the present example embodiment is substantially the same as the color filter pattern according to the example embodiment of FIG. 2 excepting that the color filter pattern 921 is not formed on the first display substrate 910, but formed on the second display substrate 920 and contacting the second base substrate 210; repetitive explanation concerning the above elements may be omitted.

A color filter pattern 921 partially overlaps the pixel areas PA1 and PA2 disposed adjacent to each other, and is disposed on the switching element 220 to contact and cover the switching element 220. For example, one color filter pattern 921 overlaps with an area adjacent to a first end of the pixel area PA1, and another color filter pattern 921 spaced apart from the color filter pattern 921 overlaps an area adjacent to a second end of the pixel area PA1. The color filter pattern 921 is not disposed in an area between the first end and the second end of the pixel area PA1, so that the second display substrate 920 may have a stepped portion. The color filter pattern 921 may include a contact hole partially exposing the switching element 220.

Alternatively, the color filter pattern 921 may have a shape of one of the color filter patterns and a corresponding relation of the color filter pattern and the pixel area according to the examples of FIGS. 4, 7, 8 and 10.

The pixel electrode PE is disposed in the pixel area (e.g., pixel area PA1) and extends from one color filter pattern 921 to another color filter pattern 921 spaced apart from the color filter pattern 921; the pixel electrode contacts two adjacent color filter patterns 921. The pixel electrode PE is electrically connected to the switching element 220 via the contact hole.

According to the present example embodiment of FIG. 11, although the color filter patterns 921 may be misaligned (or disposed asymmetrically) with respect to a pixel area along the first direction D1, the color reproducibility and the transmission rate of the display panel including the second display substrate 920 may remain substantially constant and/or substantially consistent for different pixel areas.

FIG. 12 is a cross-sectional view illustrating a second display substrate according to an example embodiment of the present invention.

A second display substrate according to the present example embodiment is substantially the same as the second display substrate according to the example embodiment of FIG. 11 except, for example, a protecting layer; thus the same reference numerals will be used to refer to the same or like parts as those described in the example embodiment of FIG. 11, and repetitive explanation concerning the above elements may be omitted.

Referring to FIG. 12, a display panel 6000 includes a first display substrate 910, a second display substrate 930 facing the first display substrate 910, and a liquid crystal layer 300 disposed between the first display substrate 910 and the second display substrate 930.

The first display substrate 910 includes a first base substrate 110 and a first blocking pattern 120. The first display substrate 910 may further include an over-coating layer 140, a common electrode layer 150, and a column spacer 160.

The second display substrate 930 includes a second base substrate 210, a switching element 220, a color filter pattern 921, a protecting layer 230, and a pixel electrode PE.

The color filter pattern 921 partially overlaps the pixel areas PA1 and PA2 disposed adjacent to each other, and is disposed on the switching element 220 to cover the switching element 220. The color filter pattern 921 may include a contact hole partially exposing the switching element 220.

The protecting layer 230 is formed on the second base substrate 210, covers the color filter pattern 921, and planarizes the second display substrate 930. The protecting layer 230 may include a contact hole partially exposing the switching element 220.

The pixel electrode PE is disposed in a pixel area (e.g., PA1) and is disposed on the protecting layer 230; the pixel electrode PE extends from one color filter pattern 921 to another color filter pattern 921 spaced apart from the color filter pattern 921. The pixel electrode PE is electrically connected to the switching element 220 via the contact holes.

According to the present example embodiment of FIG. 12, although the color filter pattern 921 may be misaligned (or disposed asymmetrically) with respect to a pixel area along the first direction D1, the color reproducibility and the transmission rate of the display panel may remain substantially constant and/or substantially consistent for different pixel areas.

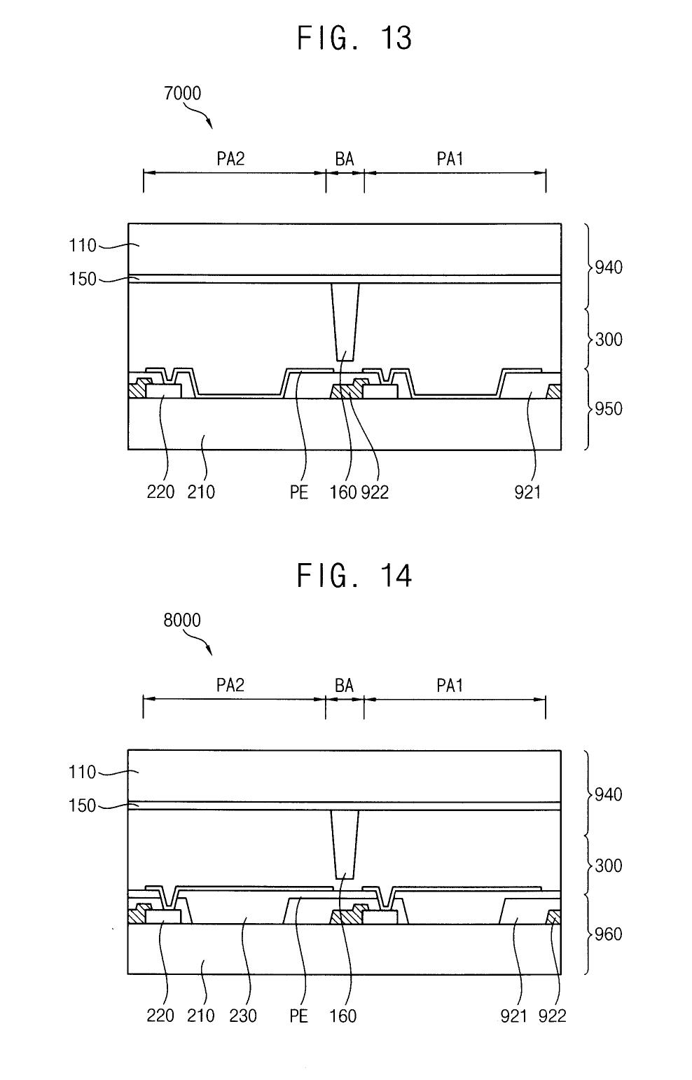

FIG. 13 is a cross-sectional view illustrating a second display substrate according to an example embodiment of the present invention.

A second display substrate according to the present example embodiment is substantially the same as the second display substrate according to the previous example embodiment of FIG. 11 except, for example, a blocking pattern and a color filter pattern, thus the same reference numerals will be used to refer to the same or like parts as those described in the previous example embodiment of FIG. 11, and repetitive explanation concerning the above elements may be omitted.

Referring to FIG. 13, a display panel 7000 includes a first display substrate 940, a second display substrate 950 facing the first display substrate 940, and a liquid crystal layer 300 disposed between the first display substrate 940 and the second display substrate 950.

The first display substrate 940 may include a first base substrate 110, a common electrode layer 150, and a column spacer 160.

The second display substrate 950 includes a second base substrate 210, a switching element 220, a first blocking pattern 922, a color filter pattern 921, and a pixel electrode PE. The first blocking pattern 922 may be formed on the switching element 220 to partially overlap with the switching element 220. Alternatively, the first blocking pattern 922 may be formed under the switching element 220 to partially overlap with the switching element 220.

The color filter pattern 921 is formed on the second base substrate 210 including the first blocking pattern 922 to cover the switching element 220 and the first blocking pattern 922.

The color filter pattern 921 partially overlaps the pixel areas PA1 and PA2 disposed adjacent to each other, and is disposed on and contacts the switching element 220 and the first blocking pattern 922 to cover the switching element 220 and the first blocking pattern 922. For example, one color filter pattern 921 overlaps with an area adjacent to a first end of the pixel area PA1, and another color filter pattern 921 overlaps with an area adjacent to a second end of the pixel area PA1. The color filter 921 is not disposed between the first end and the second end of the pixel area PA, and thus the second display substrate 950 may have a stepped portion.

According to the present example embodiment of FIG. 13, although the color filter pattern 921 may be misaligned (or disposed asymmetrically) with respect to a pixel area along the first direction D1, the color reproducibility and the transmission rate of the display panel including the second display substrate 950 may remain substantially constant and/or substantially consistent for different pixel areas.

FIG. 14 is a cross-sectional view illustrating a second display substrate according to an example embodiment of the present invention.

A second display substrate according to the present example embodiment is substantially the same as the second display substrate according to the previous example embodiment of FIG. 13 except, for example, a protecting layer; thus the same reference numerals will be used to refer to the same or like parts as those described in the previous example embodiment of FIG. 13, and repetitive explanation concerning the above elements may be omitted.

Referring to FIG. 14, a display panel 8000 includes a first display substrate 940, a second display substrate 960 facing the first display substrate 940, and a liquid crystal layer 300 disposed between the first display substrate 940 and the second display substrate 960.

The first display substrate 940 may includes a first base substrate 110, a common electrode layer 150, and a column spacer 160.

The second display substrate 960 includes a second base substrate 210, a switching element 220, a first blocking pattern 922, a color filter pattern 921, a protecting layer 230, and a pixel electrode PE. The first blocking pattern 922 is formed on the second base substrate 210 and partially overlaps with the switching element 220.

The color filter pattern 921 is formed on the second base substrate 210 and covers the switching element 220 and the first blocking pattern 922. The color filter pattern 921 may include a contact hole partially exposing the switching element 220.

The protecting layer 230 is formed on the second base substrate, covers the color filter pattern 921, and planarizes the second display substrate 960. A portion of the protecting layer 230 is disposed between adjacent color filter patterns 921. The protecting layer 230 may include a contact hole partially exposing the switching element 220.

The pixel electrode PE is disposed in a pixel area (e.g., PA1) and is disposed on the protecting layer 230; the pixel electrode PE extends from one color filter pattern 921 to another color filter pattern 921 spaced apart from the color filter pattern 921. The pixel electrode PE is electrically connected to the switching element 220 via the contact holes.

According to the example embodiment of FIG. 14, although the color filter pattern 921 may be misaligned (or disposed asymmetrically) with respect a pixel area along the first direction D1, the color reproducibility and the transmission rate of the display panel including a second display substrate 960 may remain substantially constant and/or substantially consistent for different pixel areas.

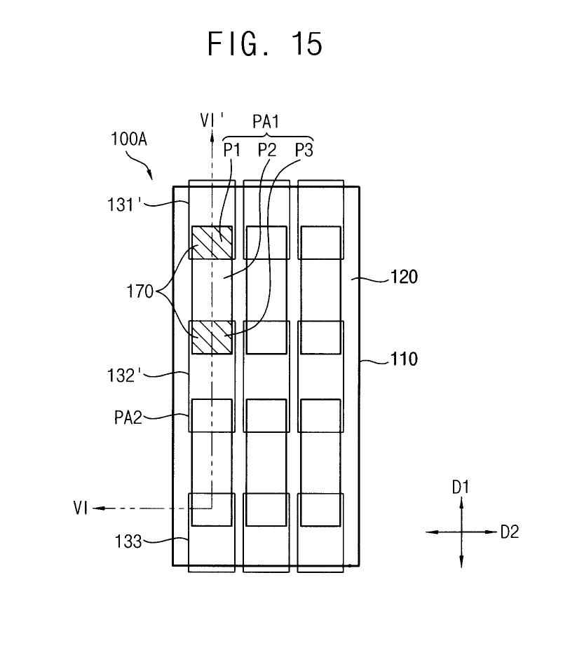

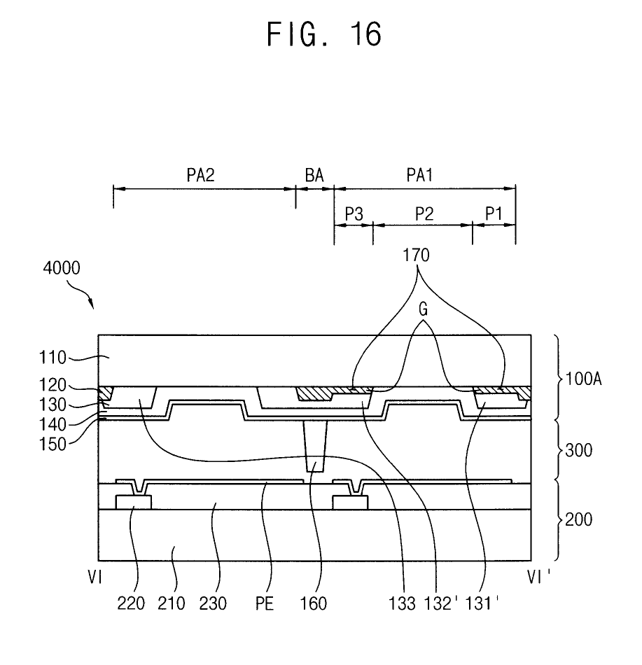

FIG. 15 is a plan view illustrating a first display substrate according to an example embodiment of the present invention. FIG. 16 is a cross-sectional view illustrating a display panel including the first display substrate taken along a line IV-IV′ of FIG. 15.

A first display substrate according to the present example embodiment is substantially the same as the first display substrate including the first display substrate according to the examples of FIGS. 1-2 except, for example, a second blocking pattern; thus the same reference numerals will be used to refer to the same or like parts as those described in the previous example embodiment of FIG. 1, and repetitive explanation concerning the above elements may be omitted.

Referring to FIG. 15 and FIG. 16, a first display substrate 100A of a display panel 4000 includes a first base substrate 110, a first blocking pattern 120, a second blocking pattern 170, and a color filter pattern 130.

The first blocking pattern 120 defines a plurality of pixel areas PA on the first base substrate 110. The pixel area PA may have a rectangular shape. The pixel area PA may have the rectangular shape extending in a first direction D1 and extending a second direction D2 crossing the first direction D1. The pixel areas PA may be spaced apart from each other by the blocking area BA, and arranged in a matrix.

The second blocking pattern 170 is disposed in a first pixel area PA1 that has a defect. For example, when at least one of a first color filter pattern 131 and a second color filter pattern 132 partially overlapping the first pixel area PA1 is partially lost/damaged or an impurity flows in at least one of the first and second color filter patterns 131 and 132, portions of the reduced first and second color filter patterns 131′ and 132′ overlapping the first pixel area PA1 is replaced by the second blocking pattern 170, in order to improve visibility, so that the first pixel area PA1 may be repaired. If a pixel area PA is fully repaired, because there is no backlight assembly, the repaired pixel area (or a defect) is more visible. According to the present example embodiment, a pixel area PA is partially repaired, although there is no backlight assembly, the repaired pixel area is less visible. Thus, the visibility may be improved.

The first and second color filter patterns 131 and 132 are adjacent to each other in the first direction D1.

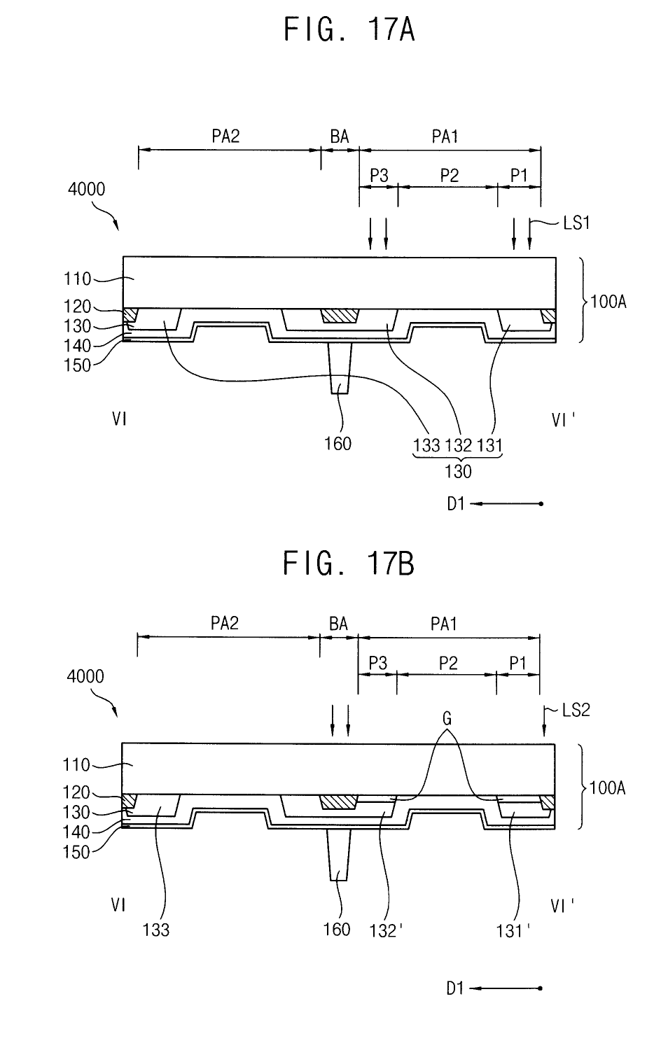

FIGS. 17A and 17B are cross-sectional views illustrating a method of repairing a first pixel area of the first display substrate of FIG. 15.

Referring to FIG. 17A and FIG. 17B, a first laser LS1 is irradiated to the first and second color filter patterns 131 and 132 overlapping with the first pixel area PA1 having the defect, so that the first and second color filter patterns 131 and 132 overlapping with the first pixel area PA1 is burned off. Thus, a gap G is formed between the first base substrate 110 and remaining first and second filter patterns 131′ and 132′. Then, a second laser LS2 is irradiated to the first blocking pattern 120 adjacent to the remaining first and second filter patterns 131′ and 132′, so that the first blocking pattern 120 flows in the gap G. Thus, the second blocking pattern 170 connected to the first blocking pattern 120 is formed between the first base substrate 110 and the remaining first and second filter patterns 131′ and 132′ at overlapping areas corresponding to portions P1 and P3. The thickness of the first blocking pattern 120 may be reduced, while the area blocked by the first blocking pattern 120 may remain substantially unchanged.

In one or more embodiments, all of the portions of the first and second color filter patterns 131 and 132 overlapping with the first pixel area PA1 (corresponding to portions P1 and P3) may be totally burned off.

When the first pixel area PA1 is divided into a first portion P1, a second portion P2, and a third portion P3 in order along the first direction D1, the second blocking pattern 170 is disposed in the first and third portions P1 and P3 overlapping the remaining first and second color filter patterns 131′ and 132′.

The second blocking pattern 170 has a length smaller than that of the first pixel area PA1 and a width larger than that of the first pixel area PA1.

A second pixel area PA2 substantially having no defect is substantially the same as the pixel area according to the example of FIG. 1, and thus repetitive explanation concerning the second pixel area PA2 will be omitted.

According to the present example embodiment of FIG. 15, the color filter patterns 131 and 132 do not correspond to the whole of the first pixel area PA1, but correspond to the first and third portions P1 and P3 of the first pixel area PA1. Thus, the portion P2 of the first pixel area PA1 is not repaired, but the first and third portions P1 and P3 of the first pixel area PA1 may be repaired.

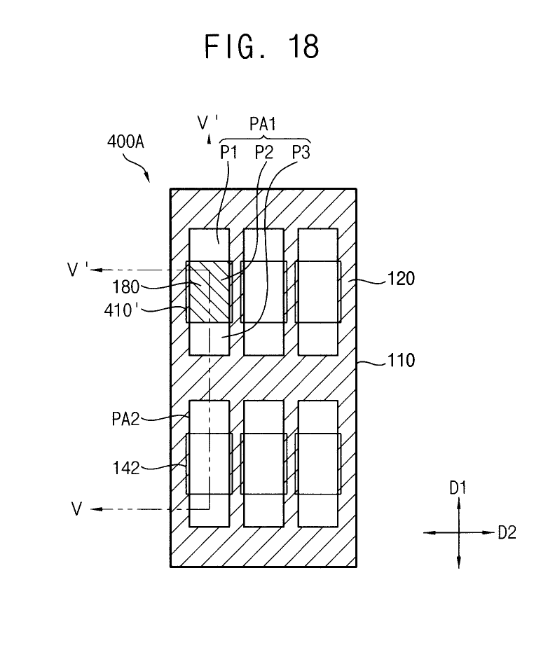

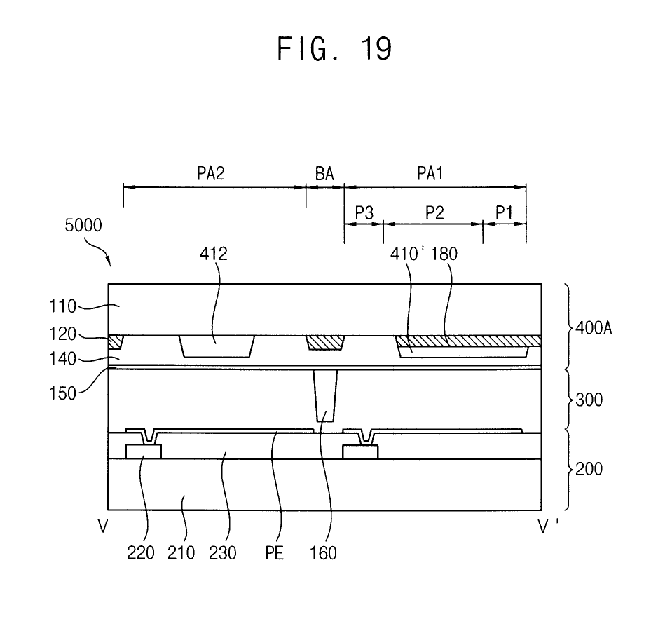

FIG. 18 is a plan view illustrating a first display substrate according to an example embodiment of the present invention. FIG. 19 is a cross-sectional view illustrating a display panel including the first display substrate taken along a line V-V′ of FIG. 18.

A first display substrate according to the present example embodiment is substantially the same as the first display substrate including the first display substrate according to the previous example embodiment of FIG. 4 except, for example, a second blocking pattern; thus the same reference numerals will be used to refer to the same or like parts as those described in the previous example embodiment of FIG. 4, and repetitive explanation concerning the above elements may be omitted.

Referring to FIG. 4, FIG. 18, and FIG. 19, a first display substrate 400A of a display panel 5000 includes a first base substrate 110, a first blocking pattern 120, a second blocking pattern 180, and a color filter pattern 410′.

The second blocking pattern 180 is disposed in a first pixel area PA1 that has a defect. For example, when the color filter pattern 410 overlapping with the first pixel area PA1 is partially lost/damaged or an impurity flows in the color filter pattern 410, a portion of the reduced color filter pattern 410′ overlapping with the first pixel area PA1 is replaced by the second blocking pattern 180 to order to improve visibility, so that the first pixel area PA1 may be repaired. If a pixel area PA is fully repaired, because there is no backlight assembly, the repaired pixel area (or a defect) is more visible. According to the present example embodiment, a pixel area PA is partially repaired, although there is no backlight assembly, the repaired pixel area is less visible. Thus, the visibility may be improved.

Hereinafter, a method of repairing the first pixel area PA1 having the defect will be explained.

A first laser LS1 is irradiated to the color filter pattern 410 overlapping with the first pixel area PA1, so that the color filter pattern 410 overlapping with the first pixel area PA1 is burned off. Thus, a gap is formed between the first base substrate 110 and remaining color filter pattern 410′. Then, a second laser LS2 is irradiated to the first blocking pattern 120 adjacent to the remaining color filter pattern 410′, so that the first blocking pattern 120 flows in the gap. Thus, the second blocking pattern 170 connected to the first blocking pattern 120 is formed between the first base substrate 110 and the remaining color filter pattern 410′.

In one or more embodiments, all of the portion of the color filter pattern 410 overlapping with the first pixel area PA1 (and corresponding to the portion P2) may be totally burned off.

When the first pixel area PA1 is divided into a first portion P1, a second portion P2 and a third portion P3 in order along the first direction D1, the second blocking pattern 420 is disposed in the second portion P2 overlapping the remaining color filter pattern 410′.

The second blocking pattern 420 has a length smaller than that of the first pixel area PA1 and a width larger than that of the first pixel area PA1.

A second pixel area PA2 substantially having no defect is substantially the same as the pixel area according to the example of FIG. 4, and thus repetitive explanation concerning the second pixel area PA2 will be omitted.

According to the present example embodiment of FIG. 18, the color filter pattern 410 does not correspond to the whole of the first pixel area PA1, but corresponds to the second portion P2 of the first pixel area PA1. Thus, the portions P1 and P3 of the first pixel area PA1 is not repaired, but the second portion P2 of the first pixel area PA1 may be repaired.

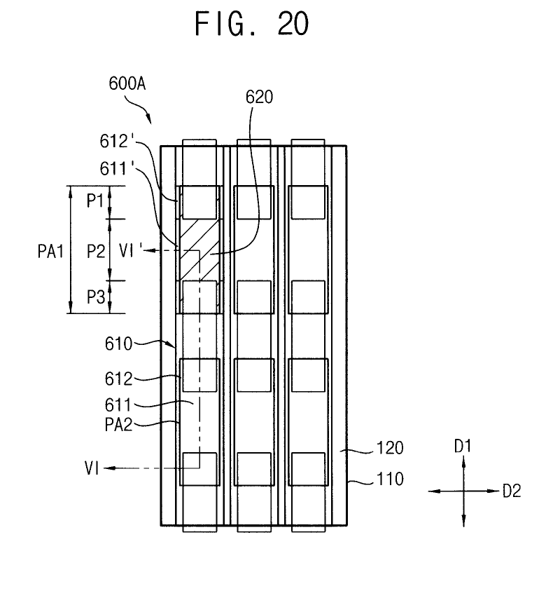

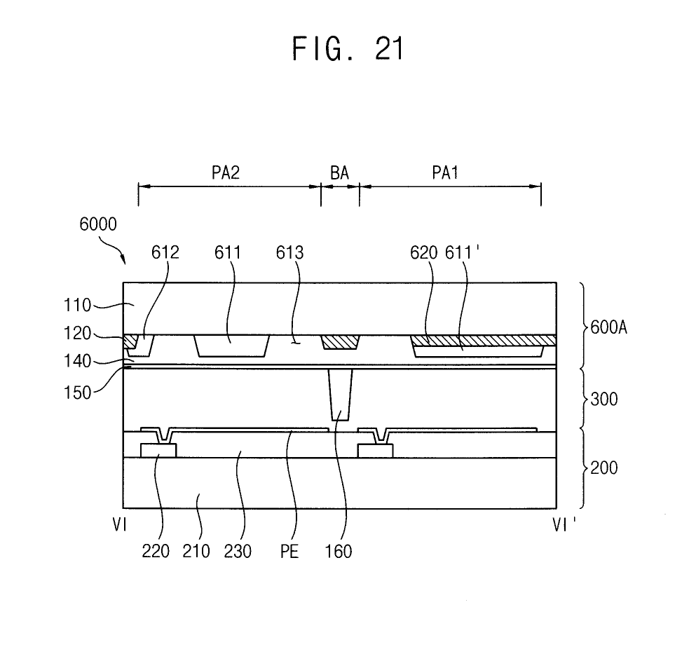

FIG. 20 is a plan view illustrating a first display substrate according to an example embodiment of the present invention. FIG. 21 is a cross-sectional view illustrating a display panel including the first display substrate taken along a line VI-VI′ of FIG. 20.

A first display substrate according to the present example embodiment is substantially the same as the first display substrate including the first display substrate according to the previous example embodiment of FIG. 8 except, for example, a second blocking pattern; thus the same reference numerals will be used to refer to the same or like parts as those described in the previous example embodiment of FIG. 8, and repetitive explanation concerning the above elements may be omitted.

Referring to FIG. 20 and FIG. 21, a first display substrate 600A of a display panel 6000 includes a first base substrate 110, a first blocking pattern 120, a second blocking pattern 620, and a color pattern 610.

The second blocking pattern 620 is disposed in a first pixel area PA1 that has a defect. For example, when the color filter pattern 610 overlapping the first pixel area PA1 is partially lost/damaged or an impurity flows in the color filter pattern 610, a portion of the color filter pattern 610 overlapping the first pixel area PA1 is replaced by the second blocking pattern 620 to order to improve visibility, so that the first pixel area PA1 may be repaired. If a pixel area PA is fully repaired, because there is no backlight assembly, the repaired pixel area (or a defect) is more visible. According to the present example embodiment, a pixel area PA is partially repaired, although there is no backlight assembly, the repaired pixel area is less visible. Thus, the visibility may be improved.

Hereinafter, a method of repairing the first pixel area PA1 having the defect will be explained.

A first laser LS1 is irradiated to portions of the color filter pattern 611 and the color connecting pattern 612 of the color pattern 610 overlapping the first pixel area PA1, so that the portions of the color filter pattern 611 and the color connecting pattern 612 overlapping with the first pixel area PA1 are burned off. Thus, gaps are formed between the first base substrate 110 and a remaining color filter pattern 611′ and between the first base substrate 110 and a remaining color connecting pattern 612′. Then, a second laser LS2 is irradiated to the first blocking pattern 120 adjacent to the remaining color filter pattern 611′ and the remaining color connecting patter 612′, so that the first blocking pattern 120 flows in the gaps. Thus, the second blocking pattern 620 connected to the first blocking pattern 120 is formed between the first base substrate 110 and each of the remaining color filter pattern 611′ and the remaining color connecting pattern 612′.

When the first pixel area PA1 is divided into a first portion P1, a second portion P2, and a third portion P3 in order along the first direction D1, the second blocking pattern 620 is disposed in the second portion P2 overlapping the remaining color filter pattern 611′ and is disposed in portions of the first and third portions P1 and P3 overlapping the remaining color connecting pattern 612′. The second blocking pattern 620 may have an ‘H’-shape. In one or more embodiments, all of the color filter pattern 611 and the color connecting pattern 612 overlapping with the first pixel area PA1 may be totally burned off.

A second pixel area PA2 substantially having no defect is substantially the same as the pixel area according to the example of FIG. 8, and thus repetitive explanation will be omitted.

According to the example of FIG. 20, the color pattern 610 does not correspond to the whole of the first pixel area PA1, but correspond to a portion of the first pixel area PA1. Thus, the first pixel area PA1 is not repaired as a whole, but the first pixel area PA1 may be partially repaired.

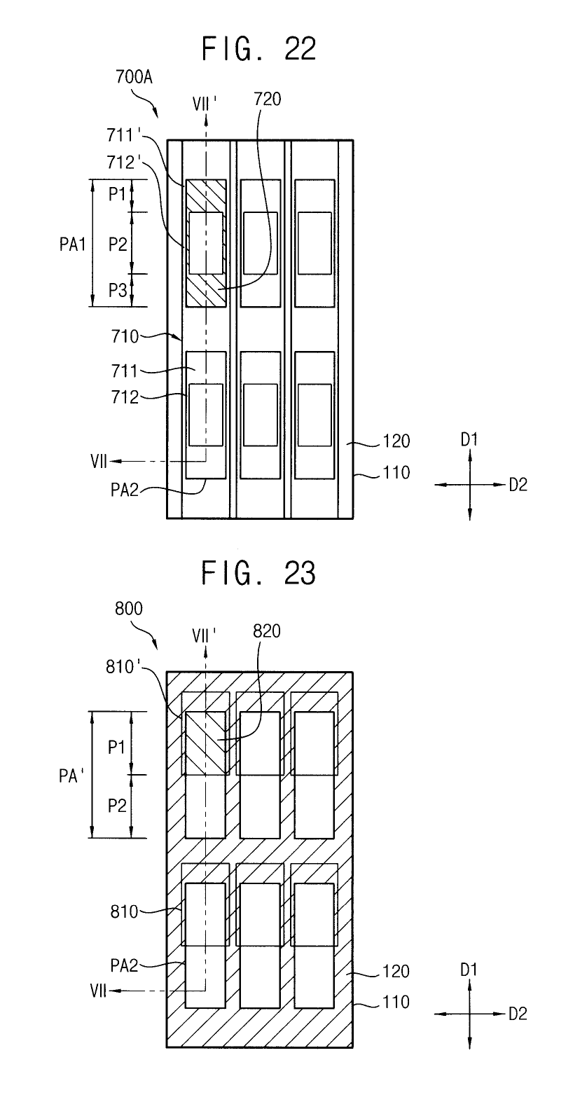

FIG. 22 is a plan view illustrating a first display substrate according to an example embodiment of the present invention.

A first display substrate according to the present example embodiment is substantially the same as the first display substrate according to the previous example embodiment of FIG. 10 except, for example, a second blocking pattern; thus the same reference numerals will be used to refer to the same or like parts as those described in the previous example embodiment of FIG. 10, and repetitive explanation concerning the above elements may be omitted.

Referring to FIG. 22, a first display substrate 700A includes a first base substrate 110, a first blocking pattern 120, a second blocking pattern 720, and a color pattern 710.

The second blocking pattern 720 is disposed in a first pixel area PA1 having a defect. For example, when the color filter pattern 710 overlapping the first pixel area PA1 is partially lost/damaged or an impurity flows in the color filter pattern 710, a portion of the color filter pattern 710 overlapping the first pixel area PA1 is replaced by the second blocking pattern 720 to order to improve visibility, so that the first pixel area PA1 may be repaired.

Hereinafter, a method of repairing the first pixel area PA1 having the defect will be explained.

A first laser LS1 is irradiated to portions of a first color filter pattern 711 and a first color connecting pattern 712 of the color pattern 710 overlapping the first pixel area PA1, so that the portions of the first color filter pattern 711 and the first color connecting pattern 712 of the color pattern 710 overlapping with the first pixel area PA1 are burned off. Thus, gaps is formed between the first base substrate 110 and a remaining first color filter pattern 711′ and between the first base substrate 110 and a remaining first color connecting pattern 712′. Then, a second laser LS2 is irradiated to the first blocking pattern 120 adjacent to the remaining first color filter pattern 711′ and the remaining first color connecting pattern 712′, so that the first blocking pattern 120 flows into the gaps. Thus, the second blocking pattern 720 is formed between the first base substrate and each of the remaining first color filter pattern 711′ and the remaining first color connecting pattern 712′. In one or more embodiments, all of the first color filter pattern 711 and the first color connecting pattern 712 overlapping with the first pixel area PA1 may be totally burned off.

When the first pixel area PA1 is divided into a first portion P1, a second portion P2 and a third portion P3 in order in the first direction D1, the second blocking pattern 720 is in the second portion P2 of the first pixel area PA1 and portions of the first and third portions P1 and P3. The second blocking pattern 720 may have a hollowed rectangular shape when viewed in a plane.

A second pixel area PA2 having no defect is substantially the same as the pixel area according to the previous example embodiment of FIG. 10, and thus any repetitive explanation will be omitted.

According to the example of FIG. 22, the color pattern 710 does not correspond to the whole of the first pixel area PA1, but correspond to a portion of the first pixel area PA1. Thus, the first pixel area PA1 is not repaired as a whole, but the first pixel area PA1 may be partially repaired.

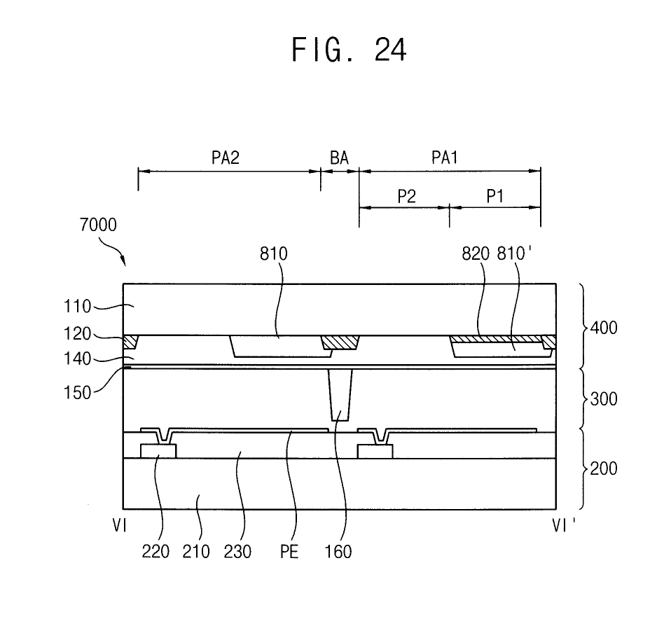

FIG. 23 is a plan view illustrating a first display substrate according to an example embodiment of the present invention. FIG. 24 is a cross-sectional view illustrating a display panel including the first display substrate taken along a line VII-VII′ of FIG. 23.

A first display substrate according to the present example embodiment is substantially the same as the first display substrate according to the examples of FIGS. 17A-17B except, for example, a relation of a second blocking pattern and a color filter pattern and a pixel area; thus the same reference numerals will be used to refer to the same or like parts as those described in the examples of FIGS. 17A-17B, and repetitive explanation concerning the above elements may be omitted.

Referring to FIG. 23 and FIG. 24, a first display substrate 800 of a display panel 7000 includes a first base substrate 110, a first blocking pattern 120, a second blocking pattern 820, and a color filter pattern 810.

The second blocking pattern 820 is disposed in a first pixel area PA1 having a defect. For example, when the color filter pattern 810 overlapping the first pixel area PA1 is partially lost/damaged or an impurity flows in the color filter pattern 810, a portion of the color filter pattern 810 overlapping the first pixel area PA1 is replaced by the second blocking pattern 820 to order to improve visibility, so that the first pixel area PA1 may be repaired.

Hereinafter, a method of repairing the first pixel area PA1 having the defect will be explained.

A first laser LS1 is irradiated to a portion of the first color filter pattern 810 overlapping the first pixel area PA1, so that the portion of the first color filter pattern 810 overlapping with the first pixel area PA1 is burned off. Thus, a gap is formed between the first base substrate 110 and a remaining first color filter pattern 810′. Then, a second laser LS2 is irradiated to the first blocking pattern 120 adjacent to the remaining first color filter pattern 810′. Thus, the second blocking pattern 820 connected to the first blocking pattern 120 is formed between the first base substrate 110 and a remaining first color filter pattern 810′. In one or more embodiments, all of the first color filter pattern 810 overlapping with the first pixel area PA1 may be totally burned off.

When the first pixel area PA1 is divided into a first portion P1 and a second portion P2 in order along the first direction D1, the second blocking pattern 820 is disposed in the first portion P1 of the first pixel area PA1. Alternatively or additionally, the second blocking pattern 820 may be disposed in the second portion P2 of the first pixel area PA1. The second blocking pattern 820 may be disposed in at least one of the first and second portions P1 and P2.

A second pixel area PA2 having no defect is substantially the same as the pixel area according to the previous example embodiment of FIG. 18, and thus any repetitive explanation will be omitted.

According to the present example embodiment of FIG. 23, the color pattern 810 does not correspond to the whole of the first pixel area PA1, but correspond to a portion of the first pixel area PA1. Thus, the first pixel area PA1 is not repaired as a whole, but the first pixel area PA1 may be partially repaired.

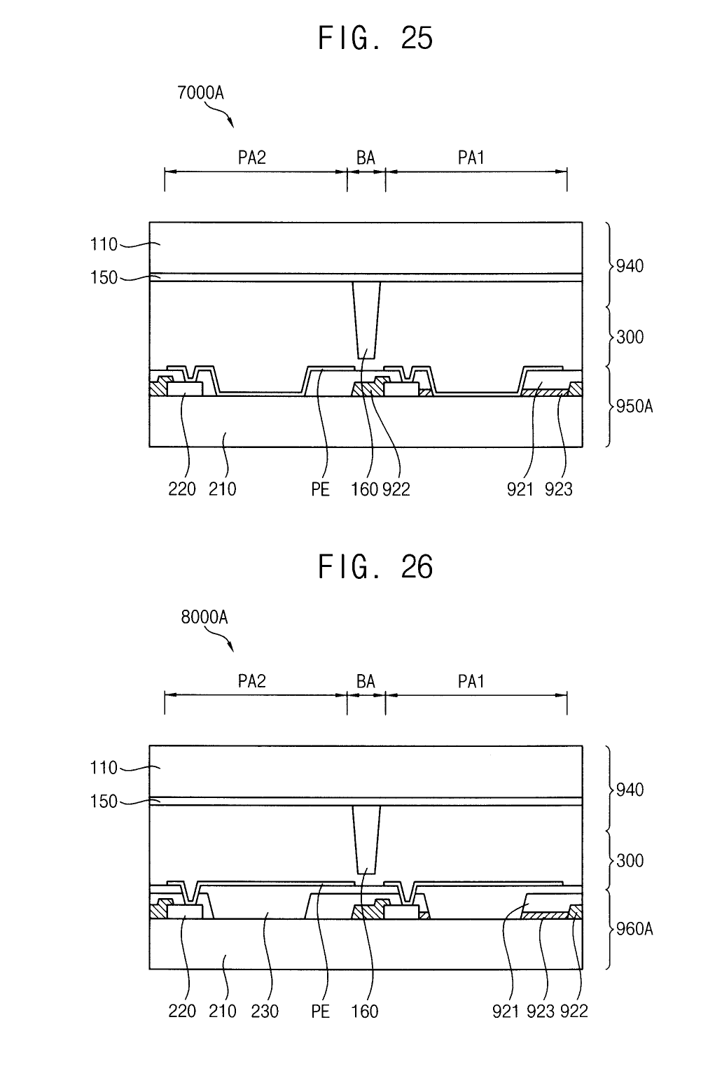

FIG. 25 is a cross-sectional view illustrating a second display substrate according to an example embodiment of the present invention.

A second display substrate according to the present example embodiment is substantially the same as the second display substrate according to the previous example embodiment of FIG. 13 except, for example, a second blocking pattern; thus the same reference numerals will be used to refer to the same or like parts as those described in the previous example embodiment of FIG. 13, and repetitive explanation concerning the above elements may be omitted.

Referring to FIG. 25, a display panel 7000A includes a first display substrate 940, a second display substrate 950A facing the first display substrate 940 and a liquid crystal layer 300 disposed between the first display substrate 940 and the second display substrate 950A.

The second display substrate 950A includes a second base substrate 210, a switching element 220, a first blocking pattern 922, a second blocking pattern 923, a color filter pattern 921, and a pixel electrode PE.

The first blocking pattern 922 defines a plurality of pixel areas PA on the second base substrate 210. The pixel area PA may have a rectangular shape. The pixel area PA may have the rectangular shape extending in a first direction D1 and a second direction D2 crossing the first direction D1. The pixel areas PA may be spaced apart from each other by the blocking area BA in which the first blocking pattern 922 is formed, and arranged in a matrix.

The first blocking pattern 922 may be formed on the switching element 220 to partially overlap the switching element 220.

The second blocking pattern 923 is disposed in a first pixel area PA1 having a defect. For example, when a portion of the color filter pattern 921 overlapping with the first pixel area PA1 is partially lost/damaged or an impurity flows in the color filter pattern 921, the portion of the color filter pattern 921 overlapping with the first pixel area PA1 is replaced by the second blocking pattern 923 to order to improve visibility, so that the first pixel area PA1 may be repaired.

A method of repairing the first pixel area PA1 is substantially the same as the method according to the examples of FIG. 17A and FIG. 17B, and thus any repetitive explanation will be omitted.

The color filter pattern 921 may be substantially the same as the color filter pattern according to the previous example embodiment of the FIGS. 4, 7, 8 and 10, so that the second blocking pattern 923 may be substantially the same as the second blocking pattern according to the previous example embodiments of FIG. 18 to FIG. 24.

According to the present example embodiment of FIG. 25, the color filter pattern 921 does not correspond to the whole of the first pixel area PA1, but correspond to a portion of the first pixel area PA1. Thus, the first pixel area PA1 is not repaired as a whole, but the first pixel area PA1 may be partially repaired.

FIG. 26 is a cross-sectional view illustrating a second display substrate according to still another example embodiment of the present invention.

A second display substrate according to the present example embodiment is substantially the same as the second display substrate according to the previous example embodiment of FIG. 25 except, for example, a second blocking pattern; thus the same reference numerals will be used to refer to the same or like parts as those described in the example embodiment of FIG. 25, and repetitive explanation concerning the above elements may be omitted.

Referring to FIG. 26, a display panel 8000A includes a first display substrate 940, a second display substrate 960A facing the first display substrate 940 and a liquid crystal layer 300 disposed between the first display substrate 940 and the second display substrate 960A.

The second display substrate 960A includes a second base substrate 210, a switching element 220, a first blocking pattern 922, a second blocking pattern 923, a color filter pattern 921, a protecting layer 230, and a pixel electrode PE.

The protecting layer 230 is formed on the second display substrate 960A including the switching element 220, a first blocking pattern 922, a second blocking pattern 923 and a color filter pattern 921, so that the second display substrate 960A may be planarized.

According to the present example embodiment of FIG. 26, the color filter pattern 921 does not correspond to the whole of the first pixel area PA1, but correspond to a portion of the first pixel area PA1. Thus, the first pixel area PA1 is not repaired as a whole, but the first pixel area PA1 may be partially repaired.

According to the present invention, although a color filter pattern is misaligned with respect to a pixel area, an area in which the color filter pattern overlaps with the pixel area may remain substantially constant and/or substantially consistent for different pixel areas, so that a transmission rate and a color reproducibility of a display panel may remain substantially constant and/or substantially consistent for different pixel areas.

A color filter pattern entirely covers a first blocking pattern between pixel areas adjacent to each other in a longitudinal direction, so that an upper surface of the first blocking pattern may be planarized. Thus, a column spacer may have a constant liquid crystal margin at any positions over the color filter pattern on the first blocking pattern.

Alternatively, the color filter pattern does not cover anything of the first blocking pattern between the pixel areas adjacent to each other in the longitudinal direction, so that an upper surface of the first blocking pattern may be planarized. Thus, the column spacer may have a constant liquid crystal margin at any positions over the first blocking pattern.

The color filter pattern partially overlaps with the pixel area, so that the pixel area may be partially repaired.

The foregoing is illustrative of the present invention and is not to be construed as limiting thereof. Although a few example embodiments of the present invention have been described, those skilled in the art will readily appreciate that many modifications are possible in the example embodiments without materially departing from the novel teachings and advantages of the present invention. Accordingly, all such modifications are intended to be included within the scope of the present invention as defined in the claims. In the claims, means-plus-function clauses are intended to cover the structures described herein as performing the recited function and not only structural equivalents but also equivalent structures. Therefore, it is to be understood that the foregoing is illustrative of the present invention and is not to be construed as limited to the specific example embodiments disclosed, and that modifications to the disclosed example embodiments, as well as other example embodiments, are intended to be included within the scope of the appended claims. The present invention is defined by the following claims, with equivalents of the claims to be included therein.

What is claimed is:

1. A display substrate comprising:
a first blocking pattern defining a plurality of pixel areas on a base substrate, the plurality of pixel areas including a first pixel area and a second pixel area disposed adjacent to each other along a first direction; and
a first color filter pattern partially overlapping each of the first pixel area and the second pixel area along the first direction.

2. The display substrate of claim 1, wherein each of the pixel areas includes a first portion, a second portion, and a third portion disposed in order along the first direction,
the first color filter pattern overlaps the third portion of the first pixel area, the first portion of the second pixel area, and a portion of the first blocking pattern between the third portion of the first pixel area and the first portion of the second pixel area.

3. The display substrate of claim 1, further comprising a color connecting pattern disposed between the first color filter pattern and a second color filter pattern adjacent to the first color filter pattern along the first direction, the color connecting pattern connecting the first color filter pattern with the second color filter pattern, the color connecting pattern overlapping the first blocking pattern.

4. The display substrate of claim 3, wherein the first color filter pattern, the second color filter pattern, and the color connecting pattern define an opening,
the opening overlaps with the second portion of the first pixel area, and
the opening has a first width along a second direction crossing the first direction, the first width being larger than a width of the first pixel area.

5. The display substrate of claim 3, wherein the first color filter pattern, the second color filter pattern, the color connecting pattern define an opening,
the opening overlaps with the second portion of the first pixel area, and
the opening has a first width along a second direction crossing the first direction, the first width being smaller than a width of the first pixel area.

6. The display substrate of claim 1, wherein the color filter pattern has a first width along a second direction crossing the first direction, the first width being larger than a width of the pixel area.

7. The display substrate of claim 1, further comprising a column spacer disposed over the color filter pattern and overlapping the first blocking pattern.

8. The display substrate of claim 1, further comprising a second blocking pattern extending from the first blocking pattern and partially overlapping the first pixel area.

9. A display substrate comprising:
a first blocking pattern defining a first pixel area, the first pixel area including a first portion, a second portion, and a third portion disposed in order along a first direction on a base substrate; and
a first color filter pattern overlapping the second portion of the first pixel area, extending in a second direction crossing the first direction, and overlapping a first portion of the first blocking pattern that is adjacent to the second portion.

10. The display substrate of claim 9, wherein the first color filter pattern overlaps portions of a plurality of pixel areas arranged along the second direction, the portions of the plurality of pixel areas corresponding to the second portion of the first pixel area.

11. The display substrate of claim 9, further comprising a color connecting pattern disposed between the first color filter pattern and a second color filter pattern overlapping a second portion of a second pixel area adjacent to the first pixel area along the first direction, the color connecting pattern connecting the first color filter pattern with the second color filter pattern, the color connecting pattern overlapping the first blocking pattern.

12. The display substrate of claim 11, wherein the first color filter pattern, the second color filter pattern, and the color connecting pattern define an opening,
the opening overlaps with the third portion of the first pixel area, a first portion of the second pixel area and the first blocking pattern between the first pixel area and the second pixel area, and
the opening has a first width along the second direction, the first width being larger than a width of the first pixel area.

13. The display substrate of claim 11, wherein the first color filter pattern, the second color filter pattern, and the color connecting pattern define an opening,
the opening overlaps the third portion of the first pixel area, a first portion of the second pixel area and the first blocking pattern between the first pixel area and the second pixel area, and
the opening has a first width along the second direction, the first width being smaller than a width of the pixel area.

14. The display substrate of claim 9, further comprising a column spacer disposed on a second portion of the first blocking pattern that is disposed between the first color filter pattern and the second color filter pattern.

15. The display substrate of claim 9, further comprising a second blocking pattern extending from the first blocking pattern and overlapping the second portion of the first pixel area.

16. A display substrate comprising:
a first blocking pattern defining a plurality of pixel areas on a base substrate, the plurality of pixel areas including a first pixel area and a second pixel area;
a color filter pattern partially overlapping the first pixel area; and
a second blocking pattern extending from the first blocking pattern and partially overlapping the second pixel area.

17. The display substrate of claim 16, wherein the plurality of pixel areas are arranged along a first direction and along a second direction crossing the first direction,
each pixel area of the plurality of the pixel areas includes a first portion, a second portion, and a third portion disposed in order along the first direction,
the color filter pattern overlaps the first and third portions of the first pixel area, and
the second blocking pattern overlaps the first and third portions of the second pixel area.

18. The display substrate of claim 16, wherein the plurality of pixel areas are arranged along a first direction and along a second direction crossing the first direction,
each pixel of the plurality of pixel areas includes a first portion, a second portion, and a third portion disposed in order in the first direction,
the color filter pattern overlaps the second portion of the first pixel area, and
the second blocking pattern overlaps the second portion of the second pixel area.

19. The display substrate of claim 16, wherein the plurality of pixel areas are arranged along a first direction and along a second direction crossing the first direction,
each pixel of the plurality of pixel areas includes a first portion and a second portion disposed in order along the first direction,
the color filter pattern overlaps one of the first portion and the second portion of the first pixel area, and
the second blocking pattern overlaps one of the first portion and the second portion of the second pixel area.

20. The display substrate of claim 16, wherein the second blocking pattern has a first length along the first direction, the first length being smaller than a length of the first pixel area, and
the second blocking pattern has a first width along the second direction, the first width being larger than or equal to a width of the first pixel area.

21. A method of repairing a display substrate, the method comprising:
irradiating a first laser to a color filter pattern that partially overlaps a pixel area, to remove at least a portion of the color filter pattern, the pixel area being defined by a first blocking pattern on a base substrate,; and
irradiating a second laser to a portion of the first blocking pattern that is adjacent to the color filter pattern, to form a second blocking pattern in at least a portion of the pixel area.

22. The method of claim 21, wherein the pixel area includes a first portion, a second portion, and a third portion in order along a first direction, and
the first laser is irradiated to the color filter pattern that correspond to the first and third portions of the pixel area.

23. The method of claim 21, wherein the pixel area includes a first portion, a second portion, and a third portion in order along a first direction, and
the first laser is irradiated to the color filter pattern that correspond to the second portion of the pixel area.

24. The method of claim 21, wherein the pixel area includes a first portion and a second portion in order along a first direction, and
the first laser is irradiated to the color filter pattern that correspond to one of the first portion and the second portion of the pixel area.

25. A display panel comprising:
a first display substrate including a first blocking pattern defining a plurality of pixel areas on a first base substrate, the plurality of pixel areas including a first pixel area and a second pixel area disposed adjacent to each other along a first direction; and
a second display substrate including a second base substrate opposite to the first display substrate, a switching element disposed on the second base substrate and corresponding to the first pixel area, and a color filter pattern disposed on the switching element and partially overlapping each of the first pixel area and the second pixel area.

26. The display panel of claim 25, wherein each pixel area of the plurality of pixel areas includes a first portion, a second portion, and a third portion in order along the first direction,
the color filter pattern overlaps the third portion of the first pixel area, the first portion of the second pixel area, and a portion of the first blocking pattern that is between the third portion of the first pixel area and the first portion of the second pixel area, and
the first direction is a longitudinal direction of the first pixel area.

27. The display panel of claim 25, wherein the second display substrate further comprises a second blocking pattern extending from the first blocking pattern and partially overlapping the first pixel area.

28. A display panel comprising:
a first display substrate including a first base substrate; and
a second display substrate including a second base substrate opposite to the first display substrate, a switching element disposed on the second base substrate, and a first blocking pattern disposed on the switching element and defining a plurality of pixel areas, the plurality of pixel areas including a first pixel area and a second pixel area adjacent to each other along a first direction, the second display substrate further including a color filter pattern disposed on the switching element and the first blocking pattern and partially overlapping each of the first pixel area and the second pixel area.

29. The display panel of claim 28, wherein the second display substrate further comprises a second blocking pattern extending from the first blocking pattern and partially overlapping the second pixel area.
